(19) United States
(12) Patent Application Publication
(10) Pub. No.: US 2025/0236291 A1
(43) Pub. Date: Jul. 24, 2025

(54) LATERAL PATH COMMITMENT

(71) Applicant: Motional AD LLC, Boston, MA (US)

(72) Inventors: Marc Dominik Heim, Boston, MA (US); Juraj Kabzan, Boston, MA (US); Abhijit Chilukuri, Boston, MA (US)

(21) Appl. No.: 19/175,934

(22) Filed: Apr. 10, 2025

Related U.S. Application Data
(63) Continuation of application No. PCT/US2023/076377, filed on Oct. 9, 2023.
(60) Provisional application No. 63/510,489, filed on Jun. 27, 2023.
(60) Provisional application No. 63/482,748, filed on Feb. 1, 2023.
(60) Provisional application No. 63/379,627, filed on Oct. 14, 2022.

(51) Int. Cl. B60W 30/10; B60W 60/00

(52) U.S. Cl. CPC B60W 30/10; B60W 60/001; B60W 2554/4045

(57) ABSTRACT

Provided are methods for lateral path commitment, which can include obtaining scene data associated with a scene of an autonomous vehicle, the autonomous vehicle navigating the scene according to a first trajectory, detecting a change to the scene based on the scene data, and based on the change to the vehicle scene, generating a plurality of second trajectories, wherein the plurality of second trajectories are different from the first trajectory. Some methods described also include comparing the plurality of second trajectories with the first trajectory, selecting a particular trajectory of the plurality of second trajectories for the autonomous vehicle based on a lateral movement plan and the comparing the plurality of second trajectories with the first trajectory, and navigating the autonomous vehicle according to the particular trajectory. Systems and computer program products are also provided.

### CROSS-REFERENCE TO RELATED APPLICATIONS

The present application is a continuation of PCT Application No. PCT/US2023/076377, filed Oct. 9, 2023, which claims the benefit of each of: U.S. Provisional Application No. 63/379,627, filed Oct. 14, 2022, U.S. Provisional Application No. 63/482,748, filed Feb. 1, 2023, and U.S. Provisional Application No. 63/510,489, filed Jun. 27, 2023, all of which are incorporated herein by reference in their entirety for all purposes.

### BACKGROUND

Autonomous vehicles may generate trajectories to navigate environments.

### BRIEF DESCRIPTION OF THE FIGURES

FIG. 1 is an example environment in which a vehicle including one or more components of an autonomous system can be implemented.

FIG. 2 is a diagram of one or more systems of a vehicle including an autonomous system.

FIG. 3 is a diagram of components of one or more devices and/or one or more systems of FIGS. 1 and 2.

FIG. 4 is a diagram of certain components of an autonomous system.

FIG. 5 is a data flow diagram illustrating an example of a planning system receiving scene data, generating trajectories, and selecting a trajectory to control an autonomous vehicle based on a lateral path commitment level and/or a lateral movement plan.

FIG. 6 is a diagram illustrating an example of an autonomous vehicle detecting a change to the environment, generating multiple trajectories, and selecting a trajectory for navigation based on a lateral movement plan.

FIG. 7 is diagram of a technique for representing a trajectory with a smooth and continuous function.

FIG. 8A is a graph diagram illustrating a graph that shows example lateral path commitment levels over time for different lateral movement plans.

FIG. 8B is a diagram illustrating a current trajectory of a vehicle and a plurality of different potential trajectories that may be generated or selected using the lateral movement plans, respectively, to control the vehicle.

FIG. 9 is a diagram that illustrates an example of how frequency dependency may relate to the rate at which subsequent trajectories are generated.

FIG. 10 is a flow diagram illustrating an example of a routine implemented by one or more processors to control navigation of an autonomous vehicle using lateral path commitment.

### DETAILED DESCRIPTION

In the following description numerous specific details are set forth in order to provide a thorough understanding of the present disclosure for the purposes of explanation. It will be apparent, however, that the embodiments described by the present disclosure can be practiced without these specific details. In some instances, well-known structures and devices are illustrated in block diagram form in order to avoid unnecessarily obscuring aspects of the present disclosure.

Specific arrangements or orderings of schematic elements, such as those representing systems, devices, modules, instruction blocks, data elements, and/or the like are illustrated in the drawings for ease of description. However, it will be understood by those skilled in the art that the specific ordering or arrangement of the schematic elements in the drawings is not meant to imply that a particular order or sequence of processing, or separation of processes, is required unless explicitly described as such. Further, the inclusion of a schematic element in a drawing is not meant to imply that such element is required in all embodiments or that the features represented by such element may not be included in or combined with other elements in some embodiments unless explicitly described as such.

Further, where connecting elements such as solid or dashed lines or arrows are used in the drawings to illustrate a connection, relationship, or association between or among two or more other schematic elements, the absence of any such connecting elements is not meant to imply that no connection, relationship, or association can exist. In other words, some connections, relationships, or associations between elements are not illustrated in the drawings so as not to obscure the disclosure. In addition, for ease of illustration, a single connecting element can be used to represent multiple connections, relationships or associations between elements. For example, where a connecting element represents communication of signals, data, or instructions (e.g., “software instructions”), it should be understood by those skilled in the art that such element can represent one or multiple signal paths (e.g., a bus), as may be needed, to affect the communication.

Although the terms first, second, third, and/or the like are used to describe various elements, these elements should not be limited by these terms. The terms first, second, third, and/or the like are used only to distinguish one element from another. For example, a first contact could be termed a second contact and, similarly, a second contact could be termed a first contact without departing from the scope of the described embodiments. The first contact and the second contact are both contacts, but they are not the same contact.

The terminology used in the description of the various described embodiments herein is included for the purpose of describing particular embodiments only and is not intended to be limiting. As used in the description of the various described embodiments and the appended claims, the singular forms “a,” “an” and “the” are intended to include the plural forms as well and can be used interchangeably with “one or more” or “at least one,” unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this description specify the presence of stated features, integers, steps, operations, elements, and/or components, but do not preclude the presence or addition of one or more other features, integers, steps, operations, elements, components, and/or groups thereof.

As used herein, the terms “communication” and “communicate” refer to at least one of the reception, receipt, transmission, transfer, provision, and/or the like of information (or information represented by, for example, data, signals, messages, instructions, commands, and/or the like). For one unit (e.g., a device, a system, a component of a device or system, combinations thereof, and/or the like) to be in communication with another unit means that the one unit is able to directly or indirectly receive information from and/or send (e.g., transmit) information to the other unit. This may refer to a direct or indirect connection that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit (e.g., a third unit located between the first unit and the second unit) processes information received from the first unit and transmits the processed information to the second unit. In some embodiments, a message may refer to a network packet (e.g., a data packet and/or the like) that includes data.

As used herein, the term “if” is, optionally, construed to mean “when”, “upon”, “in response to determining,” “in response to detecting,” and/or the like, depending on the context. Similarly, the phrase “if it is determined” or “if [a stated condition or event] is detected” is, optionally, construed to mean “upon determining,” “in response to determining,” “upon detecting [the stated condition or event],” “in response to detecting [the stated condition or event],” and/or the like, depending on the context. Also, as used herein, the terms “has”, “have”, “having”, or the like are intended to be open-ended terms. Further, the phrase “based on” is intended to mean “based at least partially on” unless explicitly stated otherwise.

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments can be practiced without these specific details. In other instances, well-known methods, procedures, components, circuits, and networks have not been described in detail so as not to unnecessarily obscure aspects of the embodiments.

### General Overview

In some aspects and/or embodiments, systems, methods, and computer program products described herein include and/or implement a method for operating an autonomous vehicle during transitions from a first trajectory or current trajectory (e.g., the trajectory on which the vehicle is traveling and/or the trajectory being used by the AV compute to control or operate the autonomous vehicle) to a new trajectory.

In particular, transitioning to a new trajectory may involve sudden changes in the lateral movement of the autonomous vehicle, which may result in levels of acceleration or jerk that are uncomfortable or unsafe to passengers. By virtue of the implementation of systems, methods, and computer program products described herein, a system may determine trajectory transition plans, which may include a lateral movement plan. By determining trajectory transition plans and lateral movement plans in accordance with aspects of this disclosure, an autonomous vehicle may generate trajectories which satisfy safety thresholds while also increasing passenger comfort by reducing (maximum) acceleration, jerk, etc. associated with the generated trajectories.

As used herein, a trajectory may generally refer to a path along which an autonomous vehicle is designed to navigate at a particular time. In certain cases, a trajectory may include temporal information that represents the times at which the autonomous vehicle is expected to arrive at one or more points along the path. In certain cases, a path may generally refer to a line in space along which the autonomous vehicle is designed to navigate and may or may not include temporal information.

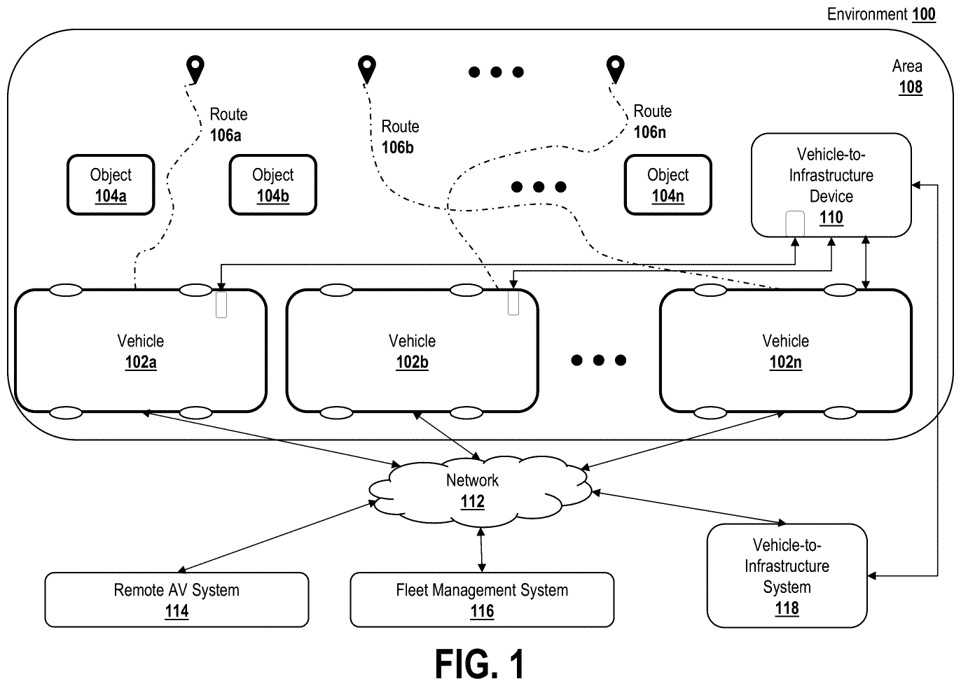

Referring now to FIG. 1, illustrated is example environment 100 in which vehicles that include autonomous systems, as well as vehicles that do not, are operated. As illustrated, environment 100 includes vehicles 102a-102n, objects 104a-104n, routes 106a-106n, area 108, vehicle-to-infrastructure (V2I) device 110, network 112, remote autonomous vehicle (AV) system 114, fleet management system 116, and V2I system 118. Vehicles 102a-102n, vehicle-to-infrastructure (V2I) device 110, network 112, autonomous vehicle (AV) system 114, fleet management system 116, and V2I system 118 interconnect (e.g., establish a connection to communicate and/or the like) via wired connections, wireless connections, or a combination of wired or wireless connections. In some embodiments, objects 104a-104n interconnect with at least one of vehicles 102a-102n, vehicle-to-infrastructure (V2I) device 110, network 112, autonomous vehicle (AV) system 114, fleet management system 116, and V2I system 118 via wired connections, wireless connections, or a combination of wired or wireless connections.

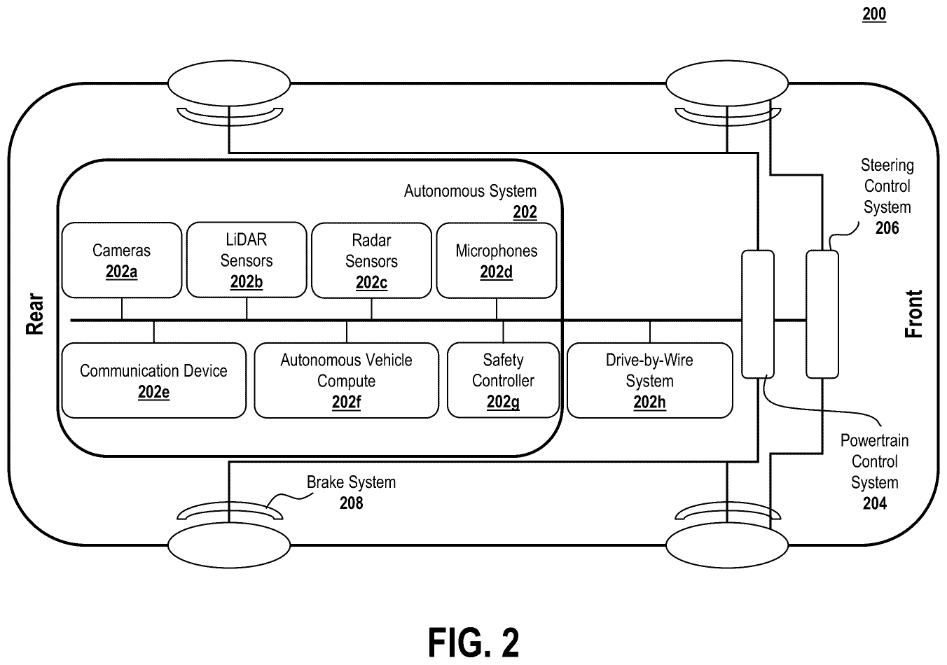

Vehicles 102a-102n (referred to individually as vehicle 102 and collectively as vehicles 102) include at least one device configured to transport goods and/or people. In some embodiments, vehicles 102 are configured to be in communication with V2I device 110, remote AV system 114, fleet management system 116, and/or V2I system 118 via network 112. In some embodiments, vehicles 102 include cars, buses, trucks, trains, and/or the like. In some embodiments, vehicles 102 are the same as, or similar to, vehicles 200, described herein (see FIG. 2). In some embodiments, a vehicle 200 of a set of vehicles 200 is associated with an autonomous fleet manager. In some embodiments, vehicles 102 travel along respective routes 106a-106n (referred to individually as route 106 and collectively as routes 106), as described herein. In some embodiments, one or more vehicles 102 include an autonomous system (e.g., an autonomous system that is the same as or similar to autonomous system 202).

Objects 104a-104n (referred to individually as object 104 and collectively as objects 104) include, for example, at least one vehicle, at least one pedestrian, at least one cyclist, at least one structure (e.g., a building, a sign, a fire hydrant, etc.), and/or the like. Each object 104 is stationary (e.g., located at a fixed location for a period of time) or mobile (e.g., having a velocity and associated with at least one trajectory). In some embodiments, objects 104 are associated with corresponding locations in area 108.

Routes 106a-106n (referred to individually as route 106 and collectively as routes 106) are each associated with (e.g., prescribe) a sequence of actions (also known as a trajectory) connecting states along which an AV can navigate. Each route 106 starts at an initial state (e.g., a state that corresponds to a first spatiotemporal location, velocity, and/or the like) and ends at a final goal state (e.g., a state that corresponds to a second spatiotemporal location that is different from the first spatiotemporal location) or goal region (e.g. a subspace of acceptable states (e.g., terminal states)). In some embodiments, the first state includes a location at which an individual or individuals are to be picked-up by the AV and the second state or region includes a location or locations at which the individual or individuals picked-up by the AV are to be dropped-off. In some embodiments, routes 106 include a plurality of acceptable state sequences (e.g., a plurality of spatiotemporal location sequences), the plurality of state sequences associated with (e.g., defining) a plurality of trajectories. In an example, routes 106 include only high level actions or imprecise state locations, such as a series of connected roads dictating turning directions at roadway intersections. Additionally, or alternatively, routes 106 may include more precise actions or states such as, for example, specific target lanes or precise locations within the lane areas and targeted speed at those positions. In an example, routes 106 include a plurality of precise state sequences along the at least one high level action sequence with a limited lookahead horizon to reach intermediate goals, where the combination of successive iterations of limited horizon state sequences cumulatively correspond to a plurality of trajectories that collectively form the high level route to terminate at the final goal state or region.

Area 108 includes a physical area (e.g., a geographic region) within which vehicles 102 can navigate. In an example, area 108 includes at least one state (e.g., a country, a province, an individual state of a plurality of states included in a country, etc.), at least one portion of a state, at least one city, at least one portion of a city, etc. In some embodiments, area 108 includes at least one named thoroughfare (referred to herein as a “road”) such as a highway, an interstate highway, a parkway, a city street, etc. Additionally, or alternatively, in some examples area 108 includes at least one unnamed road such as a driveway, a section of a parking lot, a section of a vacant and/or undeveloped lot, a dirt path, etc. In some embodiments, a road includes at least one lane (e.g., a portion of the road that can be traversed by vehicles 102). In an example, a road includes at least one lane associated with (e.g., identified based on) at least one lane marking.

Vehicle-to-Infrastructure (V2I) device 110 (sometimes referred to as a Vehicle-to-Infrastructure or Vehicle-to-Everything (V2X) device) includes at least one device configured to be in communication with vehicles 102 and/or V2I infrastructure system 118. In some embodiments, V2I device 110 is configured to be in communication with vehicles 102, remote AV system 114, fleet management system 116, and/or V2I system 118 via network 112. In some embodiments, V2I device 110 includes a radio frequency identification (RFID) device, signage, cameras (e.g., two-dimensional (2D) and/or three-dimensional (3D) cameras), lane markers, streetlights, parking meters, etc. In some embodiments, V2I device 110 is configured to communicate directly with vehicles 102. Additionally, or alternatively, in some embodiments V2I device 110 is configured to communicate with vehicles 102, remote AV system 114, and/or fleet management system 116 via V2I system 118. In some embodiments, V2I device 110 is configured to communicate with V2I system 118 via network 112.

Network 112 includes one or more wired and/or wireless networks. In an example, network 112 includes a cellular network (e.g., a long term evolution (LTE) network, a third generation (3G) network, a fourth generation (4G) network, a fifth generation (5G) network, a code division multiple access (CDMA) network, etc.), a public land mobile network (PLMN), a local area network (LAN), a wide area network (WAN), a metropolitan area network (MAN), a telephone network (e.g., the public switched telephone network (PSTN), a private network, an ad hoc network, an intranet, the Internet, a fiber optic-based network, a cloud computing network, etc., a combination of some or all of these networks, and/or the like.

Remote AV system 114 includes at least one device configured to be in communication with vehicles 102, V2I device 110, network 112, fleet management system 116, and/or V2I system 118 via network 112. In an example, remote AV system 114 includes a server, a group of servers, and/or other like devices. In some embodiments, remote AV system 114 is co-located with the fleet management system 116. In some embodiments, remote AV system 114 is involved in the installation of some or all of the components of a vehicle, including an autonomous system, an autonomous vehicle compute, software implemented by an autonomous vehicle compute, and/or the like. In some embodiments, remote AV system 114 maintains (e.g., updates and/or replaces) such components and/or software during the lifetime of the vehicle.

Fleet management system 116 includes at least one device configured to be in communication with vehicles 102, V2I device 110, remote AV system 114, and/or V2I infrastructure system 118. In an example, fleet management system 116 includes a server, a group of servers, and/or other like devices. In some embodiments, fleet management system 116 is associated with a ridesharing company (e.g., an organization that controls operation of multiple vehicles (e.g., vehicles that include autonomous systems and/or vehicles that do not include autonomous systems) and/or the like).

In some embodiments, V2I system 118 includes at least one device configured to be in communication with vehicles 102, V2I device 110, remote AV system 114, and/or fleet management system 116 via network 112. In some examples, V2I system 118 is configured to be in communication with V2I device 110 via a connection different from network 112. In some embodiments, V2I system 118 includes a server, a group of servers, and/or other like devices. In some embodiments, V2I system 118 is associated with a municipality or a private institution (e.g., a private institution that maintains V2I device 110 and/or the like).

The number and arrangement of elements illustrated in FIG. 1 are provided as an example. There can be additional elements, fewer elements, different elements, and/or differently arranged elements, than those illustrated in FIG. 1. Additionally, or alternatively, at least one element of environment 100 can perform one or more functions described as being performed by at least one different element of FIG. 1. Additionally, or alternatively, at least one set of elements of environment 100 can perform one or more functions described as being performed by at least one different set of elements of environment 100.

Referring now to FIG. 2, vehicle 200 (which may be the same as, or similar to vehicles 102 of FIG. 1) includes or is associated with autonomous system 202, powertrain control system 204, steering control system 206, and brake system 208. In some embodiments, vehicle 200 is the same as or similar to vehicle 102 (see FIG. 1). In some embodiments, autonomous system 202 is configured to confer vehicle 200 autonomous driving capability (e.g., implement at least one driving automation or maneuver-based function, feature, device, and/or the like that enable vehicle 200 to be partially or fully operated without human intervention including, without limitation, fully autonomous vehicles (e.g., vehicles that forego reliance on human intervention such as Level 5 ADS-operated vehicles), highly autonomous vehicles (e.g., vehicles that forego reliance on human intervention in certain situations such as Level 4 ADS-operated vehicles), conditional autonomous vehicles (e.g., vehicles that forego reliance on human intervention in limited situations such as Level 3 ADS-operated vehicles) and/or the like. In one embodiment, autonomous system 202 includes operational or tactical functionality required to operate vehicle 200 in on-road traffic and perform part or all of Dynamic Driving Task (DDT) on a sustained basis. In another embodiment, autonomous system 202 includes an Advanced Driver Assistance System (ADAS) that includes driver support features. Autonomous system 202 supports various levels of driving automation, ranging from no driving automation (e.g., Level 0) to full driving automation (e.g., Level 5). For a detailed description of fully autonomous vehicles and highly autonomous vehicles, reference may be made to SAE International's standard J3016: Taxonomy and Definitions for Terms Related to On-Road Motor Vehicle Automated Driving Systems, which is incorporated by reference in its entirety. In some embodiments, vehicle 200 is associated with an autonomous fleet manager and/or a ridesharing company.

Autonomous system 202 includes a sensor suite that includes one or more devices such as cameras 202a, LiDAR sensors 202b, radar sensors 202c, and microphones 202d. In some embodiments, autonomous system 202 can include more or fewer devices and/or different devices (e.g., ultrasonic sensors, inertial sensors, GPS receivers (discussed below), odometry sensors that generate data associated with an indication of a distance that vehicle 200 has traveled, and/or the like). In some embodiments, autonomous system 202 uses the one or more devices included in autonomous system 202 to generate data associated with environment 100, described herein. The data generated by the one or more devices of autonomous system 202 can be used by one or more systems described herein to observe the environment (e.g., environment 100) in which vehicle 200 is located. In some embodiments, autonomous system 202 includes communication device 202e, autonomous vehicle compute 202f, drive-by-wire (DBW) system 202h, and safety controller 202g.

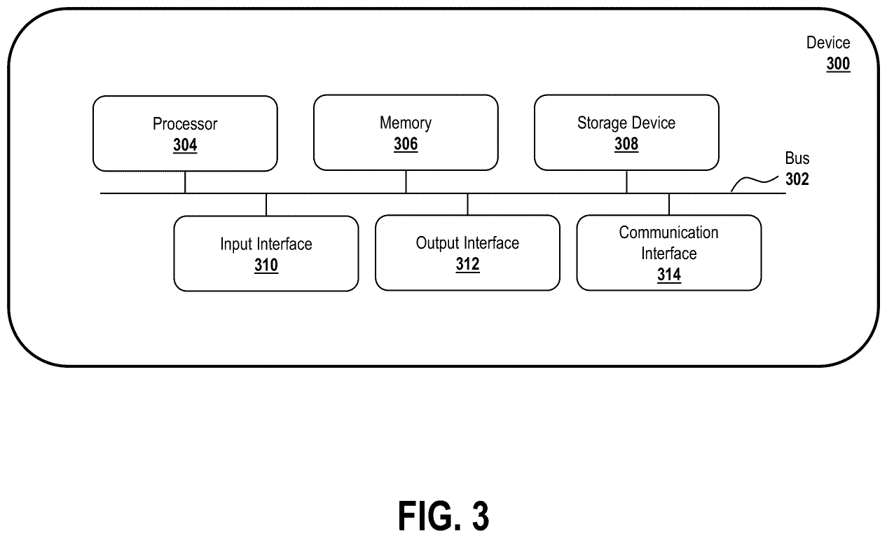

Cameras 202a include at least one device configured to be in communication with communication device 202e, autonomous vehicle compute 202f, and/or safety controller 202g via a bus (e.g., a bus that is the same as or similar to bus 302 of FIG. 3). Cameras 202a include at least one camera (e.g., a digital camera using a light sensor such as a charge-coupled device (CCD), a thermal camera, an infrared (IR) camera, an event camera, and/or the like) to capture images including physical objects (e.g., cars, buses, curbs, people, and/or the like). In some embodiments, camera 202a generates camera data as output. In some examples, camera 202a generates camera data that includes image data associated with an image. In this example, the image data may specify at least one parameter (e.g., image characteristics such as exposure, brightness, etc., an image timestamp, and/or the like) corresponding to the image. In such an example, the image may be in a format (e.g., RAW, JPEG, PNG, and/or the like). In some embodiments, camera 202a includes a plurality of independent cameras configured on (e.g., positioned on) a vehicle to capture images for the purpose of stereopsis (stereo vision). In some examples, camera 202a includes a plurality of cameras that generate image data and transmit the image data to autonomous vehicle compute 202f and/or a fleet management system (e.g., a fleet management system that is the same as or similar to fleet management system 116 of FIG. 1). In such an example, autonomous vehicle compute 202f determines depth to one or more objects in a field of view of at least two cameras of the plurality of cameras based on the image data from the at least two cameras. In some embodiments, cameras 202a is configured to capture images of objects within a distance from cameras 202a (e.g., up to 100 meters, up to a kilometer, and/or the like). Accordingly, cameras 202a include features such as sensors and lenses that are optimized for perceiving objects that are at one or more distances from cameras 202a.

In an embodiment, camera 202a includes at least one camera configured to capture one or more images associated with one or more traffic lights, street signs and/or other physical objects that provide visual navigation information. In some embodiments, camera 202a generates traffic light data associated with one or more images. In some examples, camera 202a generates TLD (Traffic Light Detection) data associated with one or more images that include a format (e.g., RAW, JPEG, PNG, and/or the like). In some embodiments, camera 202a that generates TLD data differs from other systems described herein incorporating cameras in that camera 202a can include one or more cameras with a wide field of view (e.g., a wide-angle lens, a fish-eye lens, a lens having a viewing angle of approximately 120 degrees or more, and/or the like) to generate images about as many physical objects as possible.

Light Detection and Ranging (LiDAR) sensors 202b include at least one device configured to be in communication with communication device 202e, autonomous vehicle compute 202f, and/or safety controller 202g via a bus (e.g., a bus that is the same as or similar to bus 302 of FIG. 3). LiDAR sensors 202b include a system configured to transmit light from a light emitter (e.g., a laser transmitter). Light emitted by LiDAR sensors 202b include light (e.g., infrared light and/or the like) that is outside of the visible spectrum. In some embodiments, during operation, light emitted by LiDAR sensors 202b encounters a physical object (e.g., a vehicle) and is reflected back to LiDAR sensors 202b. In some embodiments, the light emitted by LiDAR sensors 202b does not penetrate the physical objects that the light encounters. LiDAR sensors 202b also include at least one light detector which detects the light that was emitted from the light emitter after the light encounters a physical object. In some embodiments, at least one data processing system associated with LiDAR sensors 202b generates an image (e.g., a point cloud, a combined point cloud, and/or the like) representing the objects included in a field of view of LiDAR sensors 202b. In some examples, the at least one data processing system associated with LiDAR sensor 202b generates an image that represents the boundaries of a physical object, the surfaces (e.g., the topology of the surfaces) of the physical object, and/or the like. In such an example, the image is used to determine the boundaries of physical objects in the field of view of LiDAR sensors 202b.

Radio Detection and Ranging (radar) sensors 202c include at least one device configured to be in communication with communication device 202e, autonomous vehicle compute 202f, and/or safety controller 202g via a bus (e.g., a bus that is the same as or similar to bus 302 of FIG. 3). Radar sensors 202c include a system configured to transmit radio waves (either pulsed or continuously). The radio waves transmitted by radar sensors 202c include radio waves that are within a predetermined spectrum. In some embodiments, during operation, radio waves transmitted by radar sensors 202c encounter a physical object and are reflected back to radar sensors 202c. In some embodiments, the radio waves transmitted by radar sensors 202c are not reflected by some objects. In some embodiments, at least one data processing system associated with radar sensors 202c generates signals representing the objects included in a field of view of radar sensors 202c. For example, the at least one data processing system associated with radar sensor 202c generates an image that represents the boundaries of a physical object, the surfaces (e.g., the topology of the surfaces) of the physical object, and/or the like. In some examples, the image is used to determine the boundaries of physical objects in the field of view of radar sensors 202c.

Microphones 202d includes at least one device configured to be in communication with communication device 202e, autonomous vehicle compute 202f, and/or safety controller 202g via a bus (e.g., a bus that is the same as or similar to bus 302 of FIG. 3). Microphones 202d include one or more microphones (e.g., array microphones, external microphones, and/or the like) that capture audio signals and generate data associated with (e.g., representing) the audio signals. In some examples, microphones 202d include transducer devices and/or like devices. In some embodiments, one or more systems described herein can receive the data generated by microphones 202d and determine a position of an object relative to vehicle 200 (e.g., a distance and/or the like) based on the audio signals associated with the data.

Communication device 202e includes at least one device configured to be in communication with cameras 202a, LiDAR sensors 202b, radar sensors 202c, microphones 202d, autonomous vehicle compute 202f, safety controller 202g, and/or DBW (Drive-By-Wire) system 202h. For example, communication device 202e may include a device that is the same as or similar to communication interface 314 of FIG. 3. In some embodiments, communication device 202e includes a vehicle-to-vehicle (V2V) communication device (e.g., a device that enables wireless communication of data between vehicles).

Autonomous vehicle compute 202f include at least one device configured to be in communication with cameras 202a, LiDAR sensors 202b, radar sensors 202c, microphones 202d, communication device 202e, safety controller 202g, and/or DBW system 202h. In some examples, autonomous vehicle compute 202f includes a device such as a client device, a mobile device (e.g., a cellular telephone, a tablet, and/or the like), a server (e.g., a computing device including one or more central processing units, graphical processing units, and/or the like), and/or the like. In some embodiments, autonomous vehicle compute 202f is the same as or similar to autonomous vehicle compute 400, described herein. Additionally, or alternatively, in some embodiments autonomous vehicle compute 202f is configured to be in communication with an autonomous vehicle system (e.g., an autonomous vehicle system that is the same as or similar to remote AV system 114 of FIG. 1), a fleet management system (e.g., a fleet management system that is the same as or similar to fleet management system 116 of FIG. 1), a V2I device (e.g., a V2I device that is the same as or similar to V2I device 110 of FIG. 1), and/or a V2I system (e.g., a V2I system that is the same as or similar to V2I system 118 of FIG. 1).

Safety controller 202g includes at least one device configured to be in communication with cameras 202a, LiDAR sensors 202b, radar sensors 202c, microphones 202d, communication device 202e, autonomous vehicle computer 202f, and/or DBW system 202h. In some examples, safety controller 202g includes one or more controllers (electrical controllers, electromechanical controllers, and/or the like) that are configured to generate and/or transmit control signals to operate one or more devices of vehicle 200 (e.g., powertrain control system 204, steering control system 206, brake system 208, and/or the like). In some embodiments, safety controller 202g is configured to generate control signals that take precedence over (e.g., overrides) control signals generated and/or transmitted by autonomous vehicle compute 202f.

DBW system 202h includes at least one device configured to be in communication with communication device 202e and/or autonomous vehicle compute 202f. In some examples, DBW system 202h includes one or more controllers (e.g., electrical controllers, electromechanical controllers, and/or the like) that are configured to generate and/or transmit control signals to operate one or more devices of vehicle 200 (e.g., powertrain control system 204, steering control system 206, brake system 208, and/or the like). Additionally, or alternatively, the one or more controllers of DBW system 202h are configured to generate and/or transmit control signals to operate at least one different device (e.g., a turn signal, headlights, door locks, windshield wipers, and/or the like) of vehicle 200.

Powertrain control system 204 includes at least one device configured to be in communication with DBW system 202h. In some examples, powertrain control system 204 includes at least one controller, actuator, and/or the like. In some embodiments, powertrain control system 204 receives control signals from DBW system 202h and powertrain control system 204 causes vehicle 200 to make longitudinal vehicle motion, such as start moving forward, stop moving forward, start moving backward, stop moving backward, accelerate in a direction, decelerate in a direction or to make lateral vehicle motion such as performing a left turn, performing a right turn, and/or the like. In an example, powertrain control system 204 causes the energy (e.g., fuel, electricity, and/or the like) provided to a motor of the vehicle to increase, remain the same, or decrease, thereby causing at least one wheel of vehicle 200 to rotate or not rotate.

Steering control system 206 includes at least one device configured to rotate one or more wheels of vehicle 200. In some examples, steering control system 206 includes at least one controller, actuator, and/or the like. In some embodiments, steering control system 206 causes the front two wheels and/or the rear two wheels of vehicle 200 to rotate to the left or right to cause vehicle 200 to turn to the left or right. In other words, steering control system 206 causes activities necessary for the regulation of the y-axis component of vehicle motion.

Brake system 208 includes at least one device configured to actuate one or more brakes to cause vehicle 200 to reduce speed and/or remain stationary. In some examples, brake system 208 includes at least one controller and/or actuator that is configured to cause one or more calipers associated with one or more wheels of vehicle 200 to close on a corresponding rotor of vehicle 200. Additionally, or alternatively, in some examples brake system 208 includes an automatic emergency braking (AEB) system, a regenerative braking system, and/or the like.

In some embodiments, vehicle 200 includes at least one platform sensor (not explicitly illustrated) that measures or infers properties of a state or a condition of vehicle 200. In some examples, vehicle 200 includes platform sensors such as a global positioning system (GPS) receiver, an inertial measurement unit (IMU), a wheel speed sensor, a wheel brake pressure sensor, a wheel torque sensor, an engine torque sensor, a steering angle sensor, and/or the like. Although brake system 208 is illustrated to be located in the near side of vehicle 200 in FIG. 2, brake system 208 may be located anywhere in vehicle 200.

Referring now to FIG. 3, illustrated is a schematic diagram of a device 300. As illustrated, device 300 includes processor 304, memory 306, storage component 308, input interface 310, output interface 312, communication interface 314, and bus 302. In some embodiments, device 300 corresponds to at least one device of vehicles 102 (e.g., at least one device of a system of vehicles 102), and/or one or more devices of network 112 (e.g., one or more devices of a system of network 112). In some embodiments, one or more devices of vehicles 102 (e.g., one or more devices of a system of vehicles 102), and/or one or more devices of network 112 (e.g., one or more devices of a system of network 112) include at least one device 300 and/or at least one component of device 300. As shown in FIG. 3, device 300 includes bus 302, processor 304, memory 306, storage component 308, input interface 310, output interface 312, and communication interface 314.

Bus 302 includes a component that permits communication among the components of device 300. In some embodiments, processor 304 is implemented in hardware, software, or a combination of hardware and software. In some examples, processor 304 includes a processor (e.g., a central processing unit (CPU), a graphics processing unit (GPU), an accelerated processing unit (APU), and/or the like), a microphone, a digital signal processor (DSP), and/or any processing component (e.g., a field-programmable gate array (FPGA), an application specific integrated circuit (ASIC), and/or the like) that can be programmed to perform at least one function. Memory 306 includes random access memory (RAM), read-only memory (ROM), and/or another type of dynamic and/or static storage device (e.g., flash memory, magnetic memory, optical memory, and/or the like) that stores data and/or instructions for use by processor 304.

Storage component 308 stores data and/or software related to the operation and use of device 300. In some examples, storage component 308 includes a hard disk (e.g., a magnetic disk, an optical disk, a magneto-optic disk, a solid state disk, and/or the like), a compact disc (CD), a digital versatile disc (DVD), a floppy disk, a cartridge, a magnetic tape, a CD-ROM, RAM, PROM, EPROM, FLASH-EPROM, NV-RAM, and/or another type of computer readable medium, along with a corresponding drive.

Input interface 310 includes a component that permits device 300 to receive information, such as via user input (e.g., a touchscreen display, a keyboard, a keypad, a mouse, a button, a switch, a microphone, a camera, and/or the like). Additionally or alternatively, in some embodiments input interface 310 includes a sensor that senses information (e.g., a global positioning system (GPS) receiver, an accelerometer, a gyroscope, an actuator, and/or the like). Output interface 312 includes a component that provides output information from device 300 (e.g., a display, a speaker, one or more light-emitting diodes (LEDs), and/or the like).

In some embodiments, communication interface 314 includes a transceiver-like component (e.g., a transceiver, a separate receiver and transmitter, and/or the like) that permits device 300 to communicate with other devices via a wired connection, a wireless connection, or a combination of wired and wireless connections. In some examples, communication interface 314 permits device 300 to receive information from another device and/or provide information to another device. In some examples, communication interface 314 includes an Ethernet interface, an optical interface, a coaxial interface, an infrared interface, a radio frequency (RF) interface, a universal serial bus (USB) interface, a Wi-Fi® interface, a cellular network interface, and/or the like.

In some embodiments, device 300 performs one or more processes described herein. Device 300 performs these processes based on processor 304 executing software instructions stored by a computer-readable medium, such as memory 305 and/or storage component 308. A computer-readable medium (e.g., a non-transitory computer readable medium) is defined herein as a non-transitory memory device. A non-transitory memory device includes memory space located inside a single physical storage device or memory space spread across multiple physical storage devices.

In some embodiments, software instructions are read into memory 306 and/or storage component 308 from another computer-readable medium or from another device via communication interface 314. When executed, software instructions stored in memory 306 and/or storage component 308 cause processor 304 to perform one or more processes described herein. Additionally or alternatively, hardwired circuitry is used in place of or in combination with software instructions to perform one or more processes described herein. Thus, embodiments described herein are not limited to any specific combination of hardware circuitry and software unless explicitly stated otherwise.

Memory 306 and/or storage component 308 includes data storage or at least one data structure (e.g., a database and/or the like). Device 300 is capable of receiving information from, storing information in, communicating information to, or searching information stored in the data storage or the at least one data structure in memory 306 or storage component 308. In some examples, the information includes network data, input data, output data, or any combination thereof.

In some embodiments, device 300 is configured to execute software instructions that are either stored in memory 306 and/or in the memory of another device (e.g., another device that is the same as or similar to device 300). As used herein, the term “module” refers to at least one instruction stored in memory 306 and/or in the memory of another device that, when executed by processor 304 and/or by a processor of another device (e.g., another device that is the same as or similar to device 300) cause device 300 (e.g., at least one component of device 300) to perform one or more processes described herein. In some embodiments, a module is implemented in software, firmware, hardware, and/or the like.

The number and arrangement of components illustrated in FIG. 3 are provided as an example. In some embodiments, device 300 can include additional components, fewer components, different components, or differently arranged components than those illustrated in FIG. 3. Additionally or alternatively, a set of components (e.g., one or more components) of device 300 can perform one or more functions described as being performed by another component or another set of components of device 300.

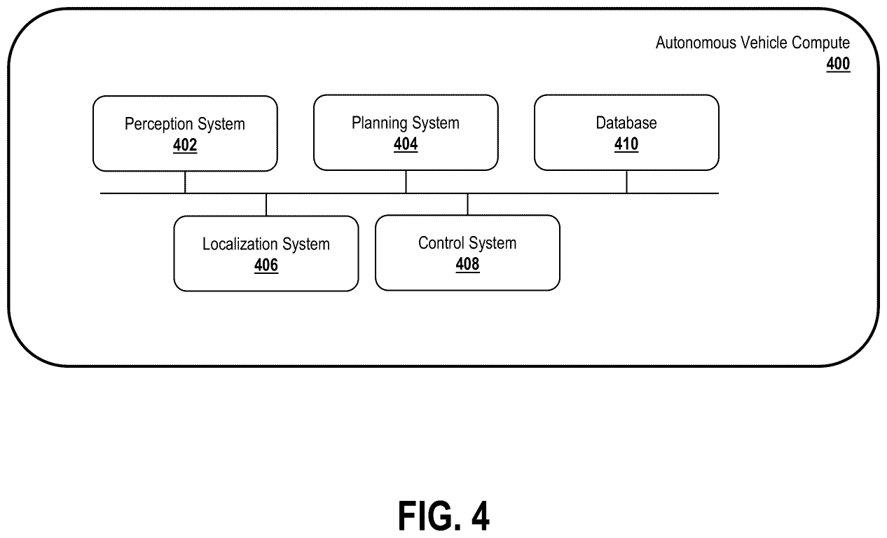

Referring now to FIG. 4, illustrated is an example block diagram of an autonomous vehicle compute 400 (sometimes referred to as an “AV stack”). As illustrated, autonomous vehicle compute 400 includes perception system 402 (sometimes referred to as a perception module), planning system 404 (sometimes referred to as a planning module), localization system 406 (sometimes referred to as a localization module), control system 408 (sometimes referred to as a control module), and database 410. In some embodiments, perception system 402, planning system 404, localization system 406, control system 408, and database 410 are included and/or implemented in an autonomous navigation system of a vehicle (e.g., autonomous vehicle compute 202f of vehicle 200). Additionally, or alternatively, in some embodiments perception system 402, planning system 404, localization system 406, control system 408, and database 410 are included in one or more standalone systems (e.g., one or more systems that are the same as or similar to autonomous vehicle compute 400 and/or the like). In some examples, perception system 402, planning system 404, localization system 406, control system 408, and database 410 are included in one or more standalone systems that are located in a vehicle and/or at least one remote system as described herein. In some embodiments, any and/or all of the systems included in autonomous vehicle compute 400 are implemented in software (e.g., in software instructions stored in memory), computer hardware (e.g., by microprocessors, microcontrollers, application-specific integrated circuits (ASICs), Field Programmable Gate Arrays (FPGAs), and/or the like), or combinations of computer software and computer hardware. It will also be understood that, in some embodiments, autonomous vehicle compute 400 is configured to be in communication with a remote system (e.g., an autonomous vehicle system that is the same as or similar to remote AV system 114, a fleet management system 116 that is the same as or similar to fleet management system 116, a V2I system that is the same as or similar to V2I system 118, and/or the like).

In some embodiments, perception system 402 receives data associated with at least one physical object (e.g., data that is used by perception system 402 to detect the at least one physical object) in an environment and classifies the at least one physical object. In some examples, perception system 402 receives image data captured by at least one camera (e.g., cameras 202a), the image associated with (e.g., representing) one or more physical objects within a field of view of the at least one camera. In such an example, perception system 402 classifies at least one physical object based on one or more groupings of physical objects (e.g., bicycles, vehicles, traffic signs, pedestrians, and/or the like). In some embodiments, perception system 402 transmits data associated with the classification of the physical objects to planning system 404 based on perception system 402 classifying the physical objects.

In some embodiments, planning system 404 receives data associated with a destination and generates data associated with at least one route (e.g., routes 106) along which a vehicle (e.g., vehicles 102) can travel along toward a destination. In some embodiments, planning system 404 periodically or continuously receives data from perception system 402 (e.g., data associated with the classification of physical objects, described above) and planning system 404 updates the at least one trajectory or generates at least one different trajectory based on the data generated by perception system 402. In other words, planning system 404 may perform tactical function-related tasks that are required to operate vehicle 102 in on-road traffic. Tactical efforts involve maneuvering the vehicle in traffic during a trip, including but not limited to deciding whether and when to overtake another vehicle, change lanes, or selecting an appropriate speed, acceleration, deacceleration, etc. In some embodiments, planning system 404 receives data associated with an updated position of a vehicle (e.g., vehicles 102) from localization system 406 and planning system 404 updates the at least one trajectory or generates at least one different trajectory based on the data generated by localization system 406.

In some embodiments, localization system 406 receives data associated with (e.g., representing) a location of a vehicle (e.g., vehicles 102) in an area. In some examples, localization system 406 receives LiDAR data associated with at least one point cloud generated by at least one LiDAR sensor (e.g., LiDAR sensors 202b). In certain examples, localization system 406 receives data associated with at least one point cloud from multiple LiDAR sensors and localization system 406 generates a combined point cloud based on each of the point clouds. In these examples, localization system 406 compares the at least one point cloud or the combined point cloud to two-dimensional (2D) and/or a three-dimensional (3D) map of the area stored in database 410. Localization system 406 then determines the position of the vehicle in the area based on localization system 406 comparing the at least one point cloud or the combined point cloud to the map. In some embodiments, the map includes a combined point cloud of the area generated prior to navigation of the vehicle. In some embodiments, maps include, without limitation, high-precision maps of the roadway geometric properties, maps describing road network connectivity properties, maps describing roadway physical properties (such as traffic speed, traffic volume, the number of vehicular and cyclist traffic lanes, lane width, lane traffic directions, or lane marker types and locations, or combinations thereof), and maps describing the spatial locations of road features such as crosswalks, traffic signs or other travel signals of various types. In some embodiments, the map is generated in real-time based on the data received by the perception system.

In another example, localization system 406 receives Global Navigation Satellite System (GNSS) data generated by a global positioning system (GPS) receiver. In some examples, localization system 406 receives GNSS data associated with the location of the vehicle in the area and localization system 406 determines a latitude and longitude of the vehicle in the area. In such an example, localization system 406 determines the position of the vehicle in the area based on the latitude and longitude of the vehicle. In some embodiments, localization system 406 generates data associated with the position of the vehicle. In some examples, localization system 406 generates data associated with the position of the vehicle based on localization system 406 determining the position of the vehicle. In such an example, the data associated with the position of the vehicle includes data associated with one or more semantic properties corresponding to the position of the vehicle.

In some embodiments, control system 408 receives data associated with at least one trajectory from planning system 404 and control system 408 controls operation of the vehicle. In some examples, control system 408 receives data associated with at least one trajectory from planning system 404 and control system 408 controls operation of the vehicle by generating and transmitting control signals to cause a powertrain control system (e.g., DBW system 202h, powertrain control system 204, and/or the like), a steering control system (e.g., steering control system 206), and/or a brake system (e.g., brake system 208) to operate. For example, control system 408 is configured to perform operational functions such as a lateral vehicle motion control or a longitudinal vehicle motion control. The lateral vehicle motion control causes activities necessary for the regulation of the y-axis component of vehicle motion. The longitudinal vehicle motion control causes activities necessary for the regulation of the x-axis component of vehicle motion. In an example, where a trajectory includes a left turn, control system 408 transmits a control signal to cause steering control system 206 to adjust a steering angle of vehicle 200, thereby causing vehicle 200 to turn left. Additionally, or alternatively, control system 408 generates and transmits control signals to cause other devices (e.g., headlights, turn signal, door locks, windshield wipers, and/or the like) of vehicle 200 to change states.

In some embodiments, perception system 402, planning system 404, localization system 406, and/or control system 408 implement at least one machine learning model (e.g., at least one multilayer perceptron (MLP), at least one convolutional neural network (CNN), at least one recurrent neural network (RNN), at least one autoencoder, at least one transformer, and/or the like). In some examples, perception system 402, planning system 404, localization system 406, and/or control system 408 implement at least one machine learning model alone or in combination with one or more of the above-noted systems. In some examples, perception system 402, planning system 404, localization system 406, and/or control system 408 implement at least one machine learning model as part of a pipeline (e.g., a pipeline for identifying one or more objects located in an environment and/or the like).

Database 410 stores data that is transmitted to, received from, and/or updated by perception system 402, planning system 404, localization system 406 and/or control system 408. In some examples, database 410 includes a storage component (e.g., a storage component that is the same as or similar to storage component 308 of FIG. 3) that stores data and/or software related to the operation and uses at least one system of autonomous vehicle compute 400. In some embodiments, database 410 stores data associated with 2D and/or 3D maps of at least one area. In some examples, database 410 stores data associated with 2D and/or 3D maps of a portion of a city, multiple portions of multiple cities, multiple cities, a county, a state, a State (e.g., a country), and/or the like). In such an example, a vehicle (e.g., a vehicle that is the same as or similar to vehicles 102 and/or vehicle 200) can drive along one or more drivable regions (e.g., single-lane roads, multi-lane roads, highways, back roads, off road trails, and/or the like) and cause at least one LiDAR sensor (e.g., a LiDAR sensor that is the same as or similar to LiDAR sensors 202b) to generate data associated with an image representing the objects included in a field of view of the at least one LiDAR sensor.

In some embodiments, database 410 can be implemented across a plurality of devices. In some examples, database 410 is included in a vehicle (e.g., a vehicle that is the same as or similar to vehicles 102 and/or vehicle 200), an autonomous vehicle system (e.g., an autonomous vehicle system that is the same as or similar to remote AV system 114, a fleet management system (e.g., a fleet management system that is the same as or similar to fleet management system 116 of FIG. 1, a V2I system (e.g., a V2I system that is the same as or similar to V2I system 118 of FIG. 1) and/or the like.

### Lateral Path Commitment

While traveling along a current trajectory or while the autonomous vehicle compute 400 uses the current trajectory to control or operate the vehicle 200, the planning system 404 may generate potential subsequent trajectories for the vehicle 200, evaluate the generated trajectories, and select one for the control system 408. In turn, the control system 408 may transition control of the autonomous vehicle 200 from the current trajectory to the subsequent trajectory received from the planning system 404. For example, the control system 408 may generate instructions for steering, accelerating, and/or applying brakes to control the autonomous vehicle 200 to follow the received subsequent trajectory.

In some cases, based on a change to the environment, the planning system 404 may generate trajectories which are significantly different from the one being used to control the vehicle 200 (e.g., the current trajectory). For example, in certain circumstances, due to a change in the environment, such as when another vehicle abruptly moves into the same lane as (and in front of) the autonomous vehicle 200 and the distance between the two vehicles is less than a threshold distance, a homotopy decision may change significantly (e.g., from “stay in lane” to “change lane”). Other example circumstances which may significantly change homotopy decisions include, but are not limited to, a pedestrian walking in the path of the vehicle 200, an obstacle suddenly arriving in the path of the autonomous vehicle 502, the autonomous vehicle 502 initiating a lane change, the autonomous vehicle 502 performing a decision change when doing slow maneuvering, etc. In response to the change in the environment, the planning system 404 may select a trajectory that biases away from the vehicle that has cut into the vehicle 200's lane.

In some cases, the planning system 404 may not use information about the current trajectory or trajectory selected in a previous cycle (e.g., the trajectory selected at a previous frame or time period for use during a current cycle and/or the trajectory being used by the control system 408 to navigate the vehicle) when generating and/or selecting a subsequent trajectory (e.g., trajectory to use to navigate the vehicle in a subsequent cycle). In addition, the planning system 404 may not include safeguards against aggressive deviation from the current trajectory. In some such cases, when a selected subsequent trajectory results in a significant change from the current trajectory, the vehicle 200 may experience sudden jerks that may compromise the comfort or safety of the passengers.

To address these issues, the planning system 404 may use information about the current trajectory or trajectory determined at a previous frame or cycle (e.g., trajectory being used to control the vehicle 200) to select and transition to a subsequent trajectory. For example, to select a subsequent trajectory, the planning system 404 may generate multiple potential (or alternate) trajectories, compare the alternate trajectories with the current trajectory, select the subsequent trajectory based on the comparison and based on (or using) a trajectory transition plan (or lateral movement plan).

In some cases, as part of selecting a subsequent trajectory (e.g., according to a lateral movement plan), the planning system 404 may penalize potential trajectories based on differences between lateral positions (over time) of the potential trajectory and the (current) lateral position of the vehicle 200 or the lateral positions (over time) of the current trajectory (e.g., trajectory being used by the control system 408 to control the vehicle 200). For example, according to the lateral movement plan, the planning system 404 may define a cost for deviating from the current trajectory in a lateral direction with respect to the current trajectory. In this way, the planning system 404 may discourage deviation and maintain temporal continuity between the current trajectory and a potential future trajectory across a number of frames.

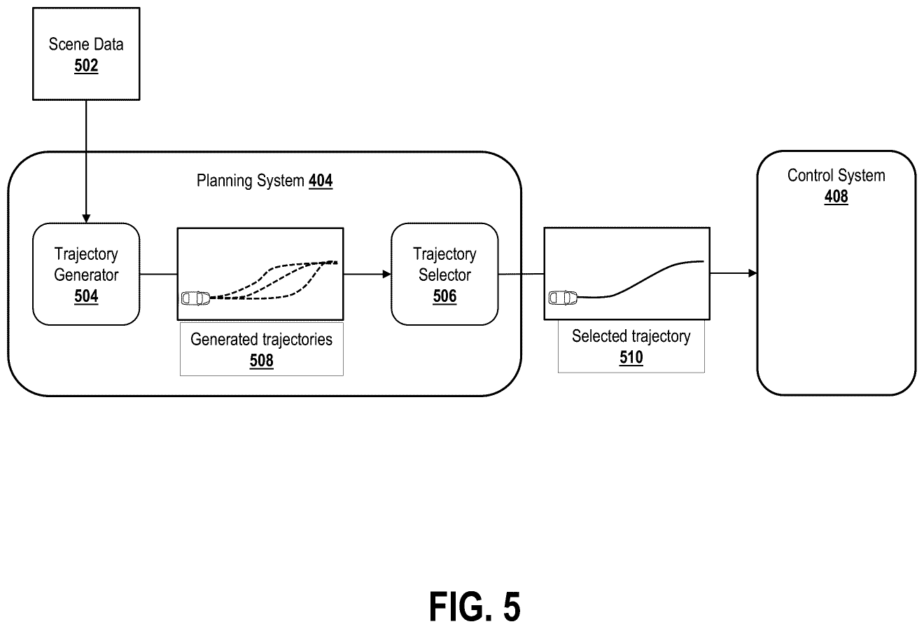

FIG. 5 is a data flow diagram illustrating an example of a planning system 404 receiving scene data 502, generating trajectories, and selecting a trajectory to control the vehicle 200 based on a lateral path commitment and/or a lateral movement plan.

The scene data 502 for a particular scene (also referred to herein as a set of scene data 502) may include data from one or more sensors in a sensor suite, data received from the perception system 402 and/or localization system 406, etc. Thus, the scene data 502 may include localization data associated with a geographic location of a vehicle 200 when the scene data 502 is collected, map data associated with a map (e.g., a semantic or annotated map) of the location of the vehicle 200 that includes annotations regarding a position of static objects or areas in the location (e.g., objects or areas that are not expected to move or change, such as drivable area, non-drivable area, traffic signs, crosswalks, sidewalks, etc.), object data associated with identified objects in the location (e.g., position, orientation, velocity, acceleration, etc. of agents), route data associated with a determined route for the vehicle 200 from a start point to a destination, etc.

In some cases, the scene data 502 includes data related to objects within the scene of the vehicle 200 at a particular time (also referred to herein as a vehicle scene), such as objects around the vehicle 200 (non-limiting example: objects, such as but not limited to pedestrian, vehicles, bicycles, etc., identified by the perception system 402), drivable area, non-drivable area, background, etc. Thus, as a vehicle scene changes (e.g., due to the vehicle 200 moving or objects around the vehicle 200 moving), the scene data 502 can change in a corresponding fashion.

As described herein, the objects in a vehicle scene and represented in the scene data 502 may include, but are not limited to pedestrians, bicycles, other vehicles, signs, curbs, buildings, etc. Moreover, the scene data 502 may include state information associated with (or about) the objects in the scene, such as but not limited to position, orientation/heading, velocity, acceleration (relative to vehicle 200 or in absolute/geographic coordinates), predicted trajectory, etc. In some cases, the planning system 404 receives the scene data 502 from another system. In certain cases, the planning system 404 generates some of the scene data 502. For example, the planning system 404 may generate a predicted trajectory of an object based on sensor data or a semantic segmentation image (also referred to herein as a semantic image, segmented image) received from the perception system 402.

In certain cases, the scene data 502 for a particular scene may include sensor data associated with one or more sensors that capture data related to the environment (e.g., cameras 202a, lidar sensors 202b, radar sensors 202c, microphones 202d, etc.).

In some cases, the scene data 502 for a particular scene may include a semantic image (e.g., generated by the perception system 402). The semantic image may include rows and columns of pixels. Some or all pixels in the semantic image can include semantic data, such as one or more feature embeddings. In certain cases, the feature embeddings can relate to one or more object attributes, such as but not limited to an object classification or class label identifying an object's classification (sometimes referred to as an object's class) (non-limiting examples: vehicle, pedestrian, bicycle, barrier, traffic cone, drivable surface, or a background, etc.). The object classification may also be referred to as pixel class probabilities or semantic segmentation scores. In some cases, the object classification for the pixels of an image can serve as compact summarized features of the image. For example, the object classifications may include a probability value that indicates the probability that the identified object classification for a pixel is correctly predicted.

In some cases, the feature embeddings can include one or more n-dimensional feature vectors. In some such cases, an individual feature vector may not correspond to an object attribute, but a combination of multiple n-dimensional feature vectors can contain information about an object's attributes, such as, but not limited to, its classification, width, length, height, etc. In certain cases, the feature embeddings can include one or more floating point numbers, which can assist a downstream model in its task of detection/segmentation/prediction.

In certain cases, the feature embeddings may include state information regarding the objects in the scene, such as but not limited to an object's position, orientation/heading, velocity, acceleration, or other information relative to the vehicle 200 or in absolute/geographic coordinates. In certain cases, the planning system 404 may generate additional feature embeddings, such as state information regarding the objects, from the scene data 502.

As described herein, the scene data 502 may be real time data generated by one or more sensors or a perception system 402 as the vehicle 200 operates in various environments. Accordingly, the scene data 502 may correspond to active vehicle scenes as the vehicle 200 travels through an environment.

In the illustrated example, the planning system 404 includes a trajectory generator 504 and a trajectory selector 506, however, it will be understood that the planning system 404 may include fewer or more components. In some cases, any and/or all of the components of the planning system 404 may be implemented using one or more processors or computer hardware (e.g., by microprocessors, microcontrollers, application-specific integrated circuits [ASICs], Field Programmable Gate Arrays (FPGAs), and/or the like). Such processors or computer hardware may be configured to execute computer-executable instructions stored on non-transitory storage media to perform one or more functions described herein. In certain cases, one or more of the components of the planning system 404, such as but not limited to the trajectory generator 504 and trajectory selector 506 may be implemented using one or more machine learning models or neural networks. Moreover, it will be understood that the trajectory generator 504 and the trajectory selector 506 may be implemented as part of the same system or sub-system (e.g., on the same hardware), as standalone systems and/or as part of another system (e.g., as part of the control system 408, etc.).

The trajectory generator 504 may generate potential trajectories 508 using the scene data 502 for a particular scene and may be implemented using one or more processors or other computer hardware, one or more machine learning models, neural networks, etc. In some cases, the trajectory generator 504 may generate hundreds or thousands or more trajectories for a particular scene based on the scene data 502 for the particular scene.

The trajectory generator 504 may generate potential trajectories 508 using a variety of techniques. In certain cases, the trajectory generator 504 may generate the potential trajectories 508 based on the kinematics of the vehicle 200, the objects identified in the vehicle scene (e.g., objects identified in the scene data 502), and/or a map of the vehicle scene (e.g., road network map and/or annotated map). In some cases, the trajectory generator 504 (alone or in combination with the trajectory selector 506) may be implemented as a model predictive control (MPC) trajectory generator.

In some cases, the trajectory generator 504 may generate one or more potential trajectories 508 at each of a plurality of frames. The trajectory generator 504 may be configured to receive a number of different inputs, including, for example, the current localization of the autonomous vehicle 200, homotopy decisions (e.g., lane change, pass before, etc.), and predictions for a set of objects. The trajectory generator 504 may generate potential trajectories 508 for the autonomous vehicle 200 over a predefined time horizon. The predefined time horizon may be, for example, 8 sec, however, other predefined time horizons are also possible without departing from aspects of this disclosure.

The trajectory selector 506 may be configured to select at least one of the potential trajectories 508 for use by the control system 408 to control the vehicle 200. The trajectory selector 506 may use a variety of factors to select a trajectory (e.g., trajectory 510) for the control system 408. In some cases, the trajectory selector 506 selects the selected trajectory 510 based on a trajectory transition plan, a lateral movement plan, and/or one or more parameters of the potential trajectories 508, such as but not limited to, lateral movement (relative to current trajectory), lateral deviation from current trajectory (over time), speed of lateral movement, lateral movement acceleration, time to lateral position endpoint (e.g., time to arrive at a new lateral position), semantic information which can include: a determination of whether the autonomous vehicle 200 is performing a lane change, a determining regarding whether to abort a lane change and go back to in-lane driving (e.g., in this case there may be no lateral commitment), a determination regarding whether there are potential safety risks, etc.

In certain cases, the trajectory selector 506 selects a trajectory that satisfies one or more thresholds. In some cases, the trajectory selector 506 may select a trajectory that satisfies a lateral acceleration threshold, etc. For example, the trajectory selector 506 may select a trajectory that has a lateral acceleration (or max lateral acceleration) that is less than a particular lateral acceleration threshold. In certain cases, the trajectory selector 506 selects a trajectory from the potential trajectories 508 with a particular value or even the lowest value for a particular parameter. For example, the trajectory selector 506 may select a trajectory from the generated potential trajectories 508 that has a particular (or lowest) lateral acceleration, a particular (or lowest) lateral movement velocity, fastest/slowest time to expected lateral position (e.g., lateral position where vehicle 200 will move to), etc.

In certain cases, the trajectory selector 506 selects a trajectory 510 that satisfies a lateral movement plan or (most closely) aligns with the lateral movement plan. For example, the trajectory selector 506 may compare the parameters of the lateral movement plan (e.g., time to begin deviation from current trajectory, rate of lateral movement, time to reach target location, etc.) with corresponding parameters of the potential trajectories 508 to select a trajectory 510 that corresponds (or most closely corresponds) to the parameters of the lateral movement plan.

In some cases, the trajectory selector 506 selects a trajectory (selected trajectory 510) by implementing a non-linear programming (NLP) problem. The NPL problem may include one or more costs that can be used to, among other things, improve or optimize comfort. For example, the costs may define parameters such as a threshold (or maximum) acceleration, a threshold (or maximum) jerk, etc. to limit the amount of discomfort induced via a generated trajectory. The NPL problem can further include one or more constraints that may be used to, among other things, improve or optimize safety. For example, the constraints may define parameters such as a safe car follow distance (e.g., threshold distance between vehicle 200 and a vehicle in front of it), drivable area bounds (e.g., threshold distances from objects or non-drivable area, etc.), etc. In some cases, the planning system 404 may solve the NLP problem via numeric optimization to select the trajectory that (best) satisfies the costs and constraints.

In certain cases, the planning system 404 may implement (e.g., using the trajectory generator 504 and/or trajectory selector 506) a kinematics model (e.g., via the NPL problem) that predicts the state of the autonomous vehicle 502 for every frame of the horizon given the current state and the control inputs at each frame. The planning system 404 may then select a trajectory that spans the horizon. In some cases, the trajectory generator 504 may select a trajectory based on the trajectory having the lowest value from the following equation:

$${min}_{x , u , λ , {x}_{C} , {u}_{C} , {λ}_{C}} {\sum }_{i = 1}^{N} ( ( 1 - {Q}_{C} ) {J}_{stage} ( {x}^{i} , {u}^{i} , {λ}^{i} ) + {Q}_{C} {J}_{stage} ( {x}_{C}^{i} , {u}_{C}^{i} , {λ}_{C}^{i} ) + ( 1 - {Q}_{C} ) {J}_{terminal} ( {x}^{N} ) + {Q}_{C} {J}_{terminal} ( {x}_{C}^{N} ) )$$

$$s . t . {x}^{i + 1} = f ( {x}^{i} , {u}^{i} )$$

$${x}_{C}^{i + 1} = f ( {x}_{C}^{i} , {u}_{C}^{i} )$$

$${C}^{i} ( {x}^{i} , {u}^{i} , {λ}^{i} ) \leq 0$$

$${C}^{i} ( {x}_{C}^{i} , {u}_{C}^{i} , {λ}_{C}^{i} ) \leq 0$$

$$x ∈ X$$

$${x}_{C} ∈ {X}_{C}$$

$$u ∈ U$$

$${u}_{C} ∈ {U}_{C}$$

$$λ ∈ Λ$$

$${λ}_{C} ∈ {Λ}_{C}$$

$${x}^{i} = {x}_{C}^{i} ∀ i \leq {i}_{pin}$$

As described herein, the control system 408 may use the selected trajectory 510 to control the autonomous vehicle. For example, the control system 408 may adjust one or more control parameters (e.g., steering wheel, accelerator, decelerator, etc.) to cause the vehicle 200 to move in a manner that (approximately) tracks the selected trajectory 510.

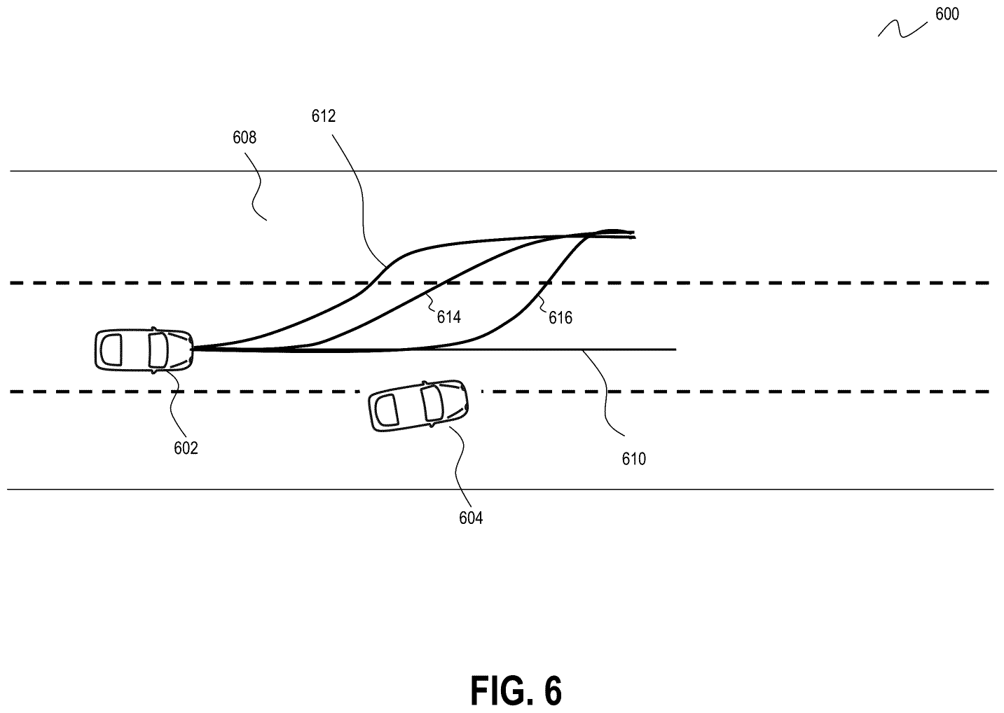

FIG. 6 is a diagram illustrating an example of an autonomous vehicle 602 (e.g., similar to vehicle 200) detecting a change to the environment, and based on the detected change, generating multiple trajectories and selecting a trajectory for navigation based on a lateral movement plan.

In the illustrated example of FIG. 6, the autonomous vehicle 602 is travelling along a first trajectory 610 on a roadway 608 when a second vehicle 604 abruptly moves (e.g., cuts) into the same lane as the autonomous vehicle 602. In response to detecting the change to the environment (e.g., the abrupt movement of the second vehicle 604 into the same lane and the expected distance between the second vehicle 604 and the vehicle 602 satisfying a threshold distance), the homotopy decision of the vehicle 602 changes from “stay in lane” to “change lanes.”

Based on the detected change to the environment or changed homotopy decision, the autonomous vehicle 602 may generate an alternate or second trajectory 612 to avoid the second vehicle 604. For example, navigating according to the second trajectory 612 may cause the vehicle 602 to move from its current lane to another lane after the cut-in by the second vehicle 604 in front of the vehicle 602. In some situations, the second trajectory 612 may include biasing away from the second vehicle 604. For example, the planning system 404 may determine that the autonomous vehicle 602 should bias (e.g., nudge) away from the second vehicle 604.

As described herein, changing from the first trajectory 610 to the second trajectory 612 may result in severe discomfort, or even possible injury, to passengers due to the amount of lateral acceleration and/or “jerk” associated with the second trajectory 612. To reduce the likelihood of discomfort or injury, in response to the determination to change trajectories (e.g., based on detecting the change in the environment or vehicle scene, such as the cut-in by the second vehicle 604 or changed homotopy decision, such as “change lanes”), the planning system 404 may generate multiple potential trajectories 612, 614, 616 for the autonomous vehicle 602 (e.g., using the trajectory generator 504). In some embodiments, the potential trajectories 612, 614, 616 include trajectories from the current position of the autonomous vehicle 602 to a position that reduces or minimizes the probability of a collision with the second vehicle 604 (e.g., a different lane).

The planning system 404 may select one of the potential trajectories 612, 614, 616 (e.g., using the trajectory selector 506), and provide the selected trajectory to the control system 408 for use in controlling the vehicle 602. In some cases, the planning system 404 may compare the current trajectory (e.g., the trajectory 610) with the potential 612, 614, 616 and/or use a lateral movement plan (or a lateral path commitment level) as part of the trajectory selection process. In some such cases, the planning system 404 may format the current trajectory 610 or generate a representation of the current trajectory to facilitate the review or comparison of the lateral movement of the trajectory. In some cases, the planning system 404 may represent the current trajectory (e.g., the first trajectory 610) as a smooth and/or continuous function.

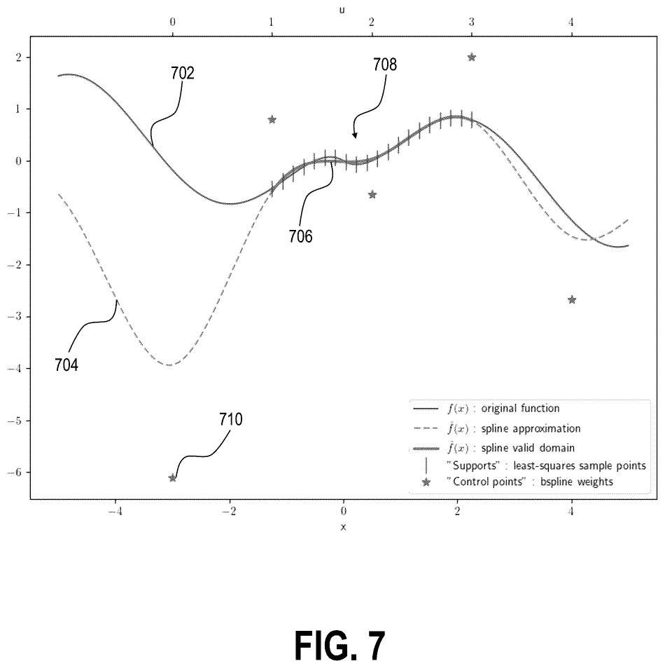

FIG. 7 is a diagram illustrating an example of a technique for representing a trajectory with a smooth and continuous function. In one example, the planning system 404 may represent the current trajectory as a B-spline. A B-spline may generally refer to a C2 continuous representation of a trajectory, which may be parametrized by a variable called “spline progress.” As used herein, the term “C2 continuous” generally refers to a relationship between two functions in which the first and second derivatives of the two functions are the same. A B-spline is one example of a smooth and continuous function that may be used to represent the current trajectory. By using a smooth and continuous representation of the (previously committed) current trajectory, the representation of the current trajectory may be directly integrated into an MPC problem.

With reference to FIG. 7, the current trajectory representation 702, a B-spline approximation 704 of the current trajectory representation 702, a valid domain 706, least-squares sampling points 708, and control points 710 are illustrated. For example, the B-spline approximation 704 may be an approximation of the current trajectory representation 702, which is valid over the valid domain 706. In generating the approximation, the least-squares sampling points 708 can be taken over the valid domain 706. In addition, the control points 710 may indicate B-spline weights that define the B-spline approximation 704. The planning system 404 (for example the trajectory selector 506) can use the B-spline approximation 704 of the current trajectory (including the control points 710 defining the B-spline approximation 704) rather than the current trajectory in selecting the selected trajectory 510 from the generated trajectories. In some embodiments, by using the B-spline approximation 704, the planning system 404 can directly integrate the B-spline approximation 704 into the MPC problem solved by the trajectory selector 506, thereby avoiding sampling of the current trajectory.

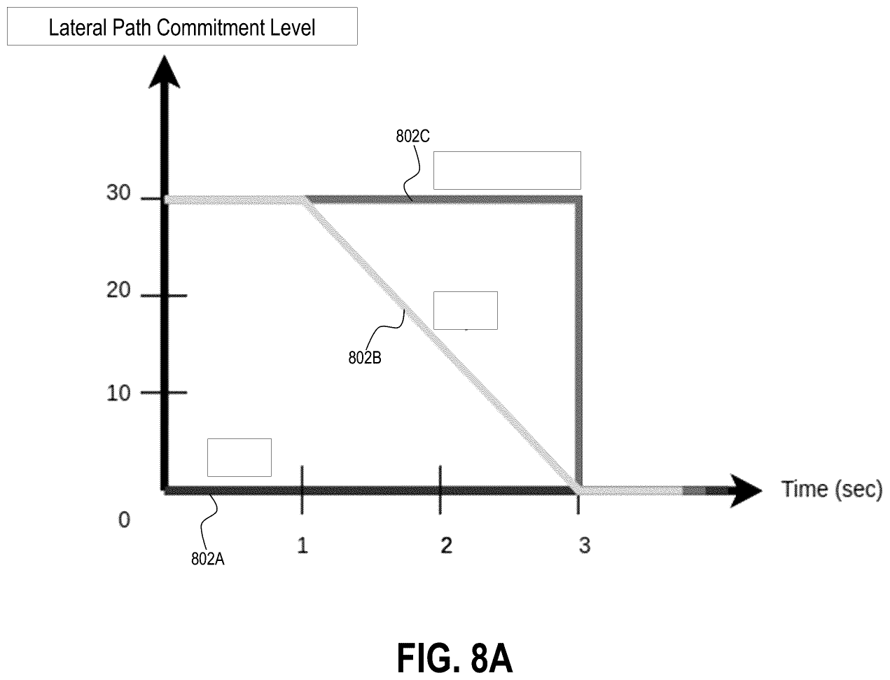

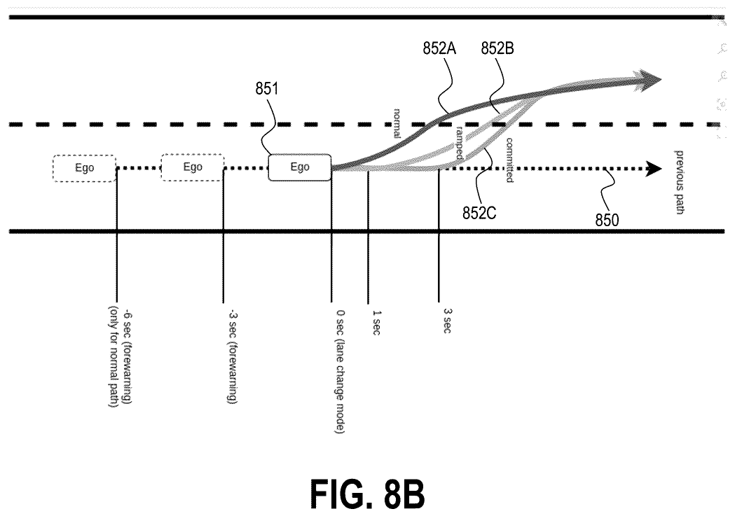

FIG. 8A is a graph diagram illustrating a graph 800 that shows example lateral path commitment levels (e.g., level of commitment to the lateral path of the current trajectory) over time for different lateral movement plans 802A-802C, and FIG. 8B is a diagram illustrating a current trajectory 850 of a vehicle 851 (similar to vehicle 200) and a plurality of different potential trajectories 852A-852C that may be generated or selected using the lateral movement plans 802A-802C, respectively, to control the vehicle 851.

The graph 800 shows the lateral path commitment level (y-axis) over time (x-axis) for a first lateral movement plan 802A, a second lateral movement plan 802B, and a third lateral movement plan 802C (individually or collectively referred to as lateral movement plan(s) 802). As illustrated in FIG. 8A, the lateral movement plans 802 may indicate the level of commitment to the lateral path of a current trajectory that a subsequent trajectory should have over time and/or indicate a cost associated with deviating from the lateral path of the current trajectory over time. The particular values illustrated for the lateral path commitment level (y-axis) may represent the relative cost values applied to the lateral movement plans 802 and other values may be used depending on the implementation without departing from aspects of this disclosure.

The lateral movement plans 802 may be used to evaluate the potential trajectories 852. For example, based on a selected lateral movement plan for a particular scenario, the planning system 404 may rank or score higher potential trajectories that map to (or more closely map to) the selected lateral movement plan than potential trajectories that do not map to (or do not map as closely to) the selected lateral movement plan. Put another away, the planning system 404 may penalize potential trajectories that do not map to the selected lateral movement plan for a particular scenario. By scoring or penalizing potential trajectories using a lateral movement plan, the planning system 404 may facilitate the selection of a trajectory that more closely maps to or aligns with the lateral movement plan that is configured to reduce lateral acceleration thereby reducing the risk of discomfort or injury.

In some cases, the planning system 404 may map potential trajectories to a lateral movement plan by determining a deviation of the potential trajectory from the current trajectory at different points in time and comparing the deviations with the lateral movement plan (e.g., verify whether the deviations of the potential trajectory from the current trajectory at different times align with or look like the lateral path commitment level of the lateral movement plan at those same times).

The first lateral movement plan 802A indicates no commitment to the lateral path of the current trajectory (or no cost for deviating from the lateral path of the current trajectory) beginning at time t=0. Based on the first lateral movement plan 802A, the planning system 404 may not penalize potential trajectories that deviate from the lateral path of the current trajectory. Moreover, a corresponding selected trajectory may begin deviating from the current trajectory upon selection of the generated trajectory for use as the subsequent trajectory for the vehicle 200 (e.g., at t=0 or immediately, considering delay for communication/implementation).

With reference to FIG. 8B, the first potential trajectory 852A is an example trajectory that may be generated or selected when the planning system 404 uses the first lateral movement plan 802A to select a subsequent trajectory. For example, the planning system 404 may select the first potential trajectory 852A using the first lateral movement plan 802A based on a determination that the first potential trajectory 852A is the potential trajectory (of the potential trajectories 852) that is similar to or most similar to the lateral movement plan 802A, or the first potential trajectory's 852A deviation from the current trajectory 850 closely (e.g., within a threshold amount) or most closely follows the deviations anticipated by the first lateral movement plan 802A when compared with the other potential trajectories 802, such as the deviation from the current trajectory 850 at zero seconds.

However, it will be understood that as the first lateral movement plan 802A applies no penalty to deviating from the current trajectory 850, the planning system 404 may use other parameters to select one of the potential trajectories 852. For example, the planning system 404 may select the first potential trajectory 852A because it reacts most quickly and/or moves to the other lane more quickly than the second potential trajectory 852B and/or the third potential trajectory 852C.

As can be seen in FIG. 8B, at time t=0, the first potential trajectory 852A begins to deviate from the current trajectory 850 (similar to the first lateral movement plan 802A). As described herein, in some cases, the first potential trajectory 852A may correspond to a lateral acceleration or speed that causes discomfort to passengers or potential injury or that satisfies a lateral acceleration or velocity threshold.

Accordingly, in certain cases, the planning system 404 may use a lateral movement plan that includes a gradual (or ramped), sloped, and/or continuous change from a high or relatively high lateral path commitment level (e.g., majority or full commitment to the path of the current trajectory or minority or no deviation from the path of the current trajectory) to a relatively low lateral path commitment level (e.g., minority or no commitment to the path of the current trajectory or majority or full deviation from the path of the current trajectory). In certain cases, the gradual, sloped, or continuous change may include a (continuously) decreasing or sloped reduction in the lateral path commitment level over a particular time period. In certain cases, the planning system 404 may determine a size of the rate of change for the gradual, sloped, or continuous change that satisfies a slope threshold (e.g., the slope of the decreasing lateral path commitment level is greater than a particular slope). The slope threshold may be based on a lateral acceleration threshold or lateral movement speed such that the rate of change of the lateral path commitment level reduces the likelihood that the lateral acceleration or lateral speed experienced by a passenger does not exceed the lateral acceleration threshold or lateral speed threshold, respectively.

The second lateral movement plan 802B is a piecewise or segmented plan that maintains a higher (e.g., majority or full) lateral commitment to the path of the current trajectory for a first time period (e.g., from 0 to 1 second) and provides a continuously descending lateral path commitment level (e.g., to a minority or no lateral commitment to the path of the current trajectory) over a second time period (e.g., from 1 second to 3 seconds). After the second time period, the lateral movement plan 802B provides little to no commitment to the current trajectory. Although the lateral movement plans 802 illustrated in FIG. 8B include changes to the applied costs at different timings, the particular timing of changes to the commitment to the path of the current trajectory can vary depending on the implementation.

As described herein, depending on the slope of the continuously descending lateral path commitment level, the second lateral movement plan 802B may result in a lateral acceleration that satisfies the slope threshold and/or reduces the likelihood that a passenger will feel discomfort (or be injured) as the vehicle 200 transitions from the current trajectory to a subsequent trajectory.

With reference to FIG. 8B, the potential trajectory 852B is an example trajectory that may be generated or selected when the planning system 404 uses the second lateral movement plan 802B to select a subsequent trajectory. For example, the planning system 404 may select the second potential trajectory 852B using the second lateral movement plan 802B based on a determination that the second potential trajectory 852B is the potential trajectory (of the potential trajectories 852) that is similar to or most similar to the second lateral movement plan 802B. As another example, the planning system 404 may select the second potential trajectory 852B based on a determination that the second potential trajectory's 852B deviation from the current trajectory 850 closely (e.g., within a threshold amount) or more closely follows the deviations expected by the second lateral movement plan 802B as compared with the other potential trajectories 852 (e.g., such as no deviation for the first one second).

As can be seen in FIG. 8B, the second potential trajectory 852B maintains continuity with (e.g., does not meaningfully deviate from) the current trajectory 850 from zero to one second (as expected by the second lateral movement plan 802B), begins to increasingly deviate more from the current trajectory 850 from one to three seconds (as expected by the second lateral movement plan 802B), and no longer has any level of commitment to the current trajectory 850 at three seconds (as expected by the second lateral movement plan 802B). As can be seen, the 852B's rate of deviation from the current trajectory 850 and the rate at which the second potential trajectory 852B moves from one lane to the next is smaller than the first potential trajectory 852A's rate of deviation from current trajectory 850 and rate at which the first potential trajectory 852A moves from one lane to another, which is indicative of a smaller lateral acceleration profile. As described herein, in some cases, a trajectory like the second potential trajectory 852B may correspond to a lateral acceleration or speed that reduces the likelihood of discomfort or injury to passengers and/or that does not satisfy a lateral acceleration or velocity threshold.

In some cases, as part of selecting between the potential trajectories 852, the planning system 404 may penalize the first potential trajectory 852A for deviating from the current trajectory 850 from zero to one second and/or not penalize (or rate higher) the second potential trajectory 852B and third potential trajectory 852C for maintaining continuity with the current trajectory 850. Moreover, the planning system 404 may penalize the first potential trajectory 852A for the relatively large lateral deviation from the current trajectory 850 (compared to the lateral deviation of the second potential trajectory 852B from the current trajectory 850) from one to three seconds. In addition, the planning system 404 may rank the second potential trajectory 852B higher than third potential trajectory 852C as it initiates movement from the current trajectory 850 earlier than the third potential trajectory 852C and/or based on the lateral acceleration of the second potential trajectory 852B being lower than the lateral acceleration of the third potential trajectory 852C. Similarly, the planning system 404 may rank the second potential trajectory 852B higher than first potential trajectory 852A as its lateral acceleration is lower than the lateral acceleration of the first potential trajectory 852A.

The third lateral movement plan 802C is a stepped plan that provides full lateral commitment to the path of the current trajectory for a third length of time (e.g., from 0 sec to 3 sec) and a step to no lateral commitment to the path after the third length of time has elapsed.

With reference to FIG. 8B, the potential trajectory 852C is an example trajectory that may be generated or selected when the planning system 404 uses the third lateral movement plan 802C to select a subsequent trajectory. As can be seen in FIG. 8B, the third potential trajectory 852C maintains continuity with (e.g., does not deviate from) the current trajectory 850 from zero to three seconds (similar to third lateral movement plan 802C), and at three seconds, the third potential trajectory 852C deviates from and no longer has any level of commitment to the current trajectory 850 (similar to third lateral movement plan 802C).

In some cases, as part of selecting between the potential trajectories 852, the planning system 404 may penalize the first potential trajectory 852A and the second potential trajectory 852B for deviating from the current trajectory 850 from zero to three seconds and/or not penalize (or rate higher) the third potential trajectory 852C for maintaining continuity with the current trajectory 850 during that time period. While the third potential trajectory 852C may be ranked higher by the planning system 404 (using the third lateral movement plan 802C) for maintaining continuity with the current trajectory 850, the third potential trajectory 852C may result in a lateral acceleration that causes discomfort or injury to a passenger. Accordingly, in some cases, the planning system 404 may select the second lateral movement plan 802B for use in generating/selecting subsequent trajectories.

It will be understood that the lateral movement plans 802 are exemplary and other plans may be used. For example, the lateral movement plans 802 may be continuous, stepped, and/or piecewise. For example, a stepped lateral movement plan may include multiple steps (e.g., a stepped, piecewise plan) over different time periods (e.g., step from 30 to 20 at t=1, step from 20 to 10 at t=2, and step from 10 to 0 at t=3). As another example, the slope of the changing lateral path commitment level for a continuous and/or piecewise plan may vary such that the lateral path commitment level decreases faster (or possibly increases or remains flat) at an earlier time period or later time period relative to other time periods. In some cases, a piecewise lateral movement plan may include a combination of one or more gradual decreases and one or more step-wise decreases. For example, the lateral path commitment level may drop from 30 to 20 at t=1 and decrease at a constant rate from 20 to 0 from one second to three seconds. Multiple continuous changes or stepwise changes may be used in any order or combination. For example, the lateral path commitment level may decrease (in a sloped or stepwise fashion), be flat, increase (in a sloped or stepwise fashion), be flat, and then decrease (in a sloped or stepwise fashion), etc. In some cases, the lateral movement plan may have a single lateral path commitment level for the duration of the plan. With reference to FIG. 8A, a lateral movement may have a lateral path commitment of 10 or 20 during three seconds or more. In this way, a corresponding potential trajectory may deviate from the current trajectory, but at a smaller amount then it would otherwise without the lateral path commitment level. Any combination of the aforementioned examples may be used as part of a lateral movement plan.

By using a lateral movement plan that includes smaller changes (e.g., multiple steps or sloped changes) from a higher or full lateral path commitment level to a lower or no lateral path commitment level, the planning system 404 may generate/select a trajectory which includes less deviation from the current trajectory over a short period of time, and thus, reduce discomfort for passengers associated with higher lateral acceleration and/or jerk.

In some cases, the trajectory transition plan and/or lateral movement plan may include a relatively low or no lateral path commitment level to the longitudinal portion of the current trajectory. For example, to enable the autonomous vehicle 602 to safely brake in response to a potential collision, the lateral path commitment plan may not apply any limitations on the acceleration/deceleration of the autonomous vehicle 602.

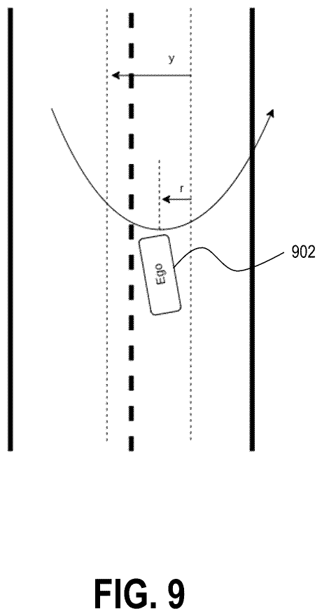

FIG. 9 is a diagram that illustrates an example of how frequency dependency may relate to the rate at which subsequent trajectories are generated. For example, subsequent trajectories may drift at a rate that is dependent on the frequency at which the subsequent trajectories are updated. This drift can be addressed by normalizing the costs other than the trajectory commitment level involved in generating trajectories with respect to the frequency of generating subsequent trajectories. Such normalization may make these costs independent of the frequency of trajectory updates, thereby reducing or eliminating frequency drift. This may also reduce the maximum steering angle generated while following the trajectories, thereby providing a more predictable lateral movement of the autonomous vehicle 902.

With reference to FIG. 9, the autonomous vehicle 902 may be attempting a left lane change. The variable r may be the lateral position which may have been dictated by the current trajectory. The variable y may be the new lateral position of ego that balances costs (e.g., within the MPC problem). The variable c may be the gradient coming from all other costs other than trajectory commitment level.

The below equations show that the new lateral position y after n frames is linearly dependent on n. Thus, the new lateral position y is dependent on how many iterations there are in a fixed period of time (e.g., the frequency of generating new trajectories n). By normalizing the cost c (e.g., c→c/n), the cost c can be made independent of the frequency n. Thus, the trajectory generator 506 can use a normalized cost c/n in selecting the potential trajectories 508 as described in connection with FIG. 5.

$$\frac{d}{dy} {( y - r )}^{2} + c = 0$$

$$⇒ 2 y - 2 r + c = 0$$

$$⇒ y = r - \frac{c}{2}$$

$$⇒ {r}^{+} = {r}^{-} - \frac{c}{2}$$

$$⇒ {r}^{( n )} = {r}^{( 0 )} - n \frac{c}{2}$$

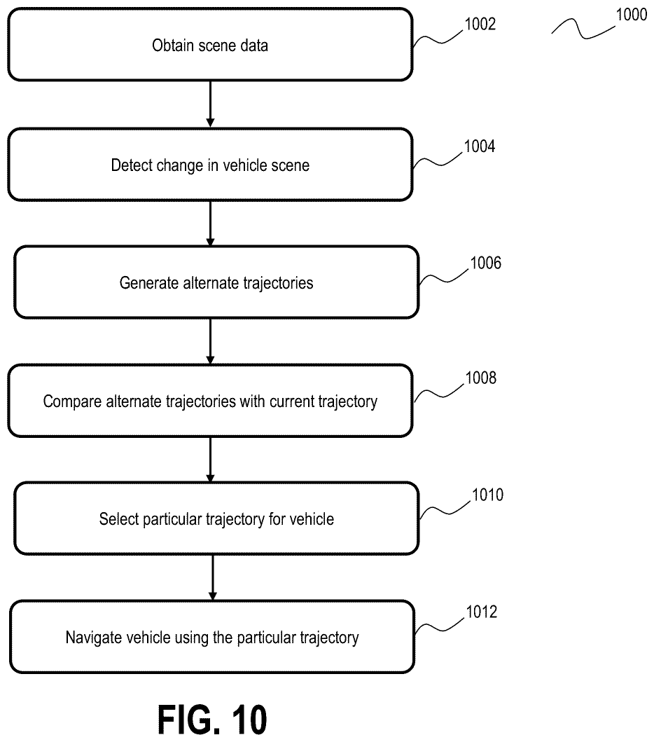

FIG. 10 is a flow diagram illustrating an example of a routine 1100 implemented by one or more processors to control navigation of an autonomous vehicle using lateral path commitment. The flow diagram illustrated in FIG. 10 is provided for illustrative purposes only. It will be understood that one or more of the steps of the routine illustrated in FIG. 10 may be removed or that the ordering of the steps may be changed. Furthermore, for the purposes of illustrating a clear example, one or more particular system components are described in the context of performing various operations during each of the data flow stages. However, other system arrangements and distributions of the processing steps across system components may be used.

At block 1002, the planning system 404 obtains scene data 502 associated with a scene of a vehicle 200. As described herein, the scene data 502 may include a semantic image and/or classifications of object within a vehicle scene. In some cases, the scene data received at 1002 is real-time scene data generated using sensor data obtained from sensors as a vehicle 200 operates in an environment. As described herein, the planning system 404 may obtain the scene data while the autonomous vehicle is navigating the vehicle scene according to a first trajectory.

At block 1004, the planning system 404 detects a change to the vehicle scene (or environment of the autonomous vehicle) based on the scene data. In certain cases, the planning system 404 detects a change to the vehicle scene based on a changed homotopy decision, such as “change lanes.” In some cases, detecting a change to the vehicle may include detecting a vehicle, pedestrian, or other object has moved into the path of the trajectory as the vehicle 200 (e.g., into the same lane) and/or is within a threshold distance of the vehicle 200.

In some cases, the threshold distance may vary. For example, the threshold distance may depend on the velocity of the vehicle 200, a velocity of the object that moved into the path of the trajectory of the vehicle 200, and/or a differential velocity between the vehicle 200 and the object. For example, the threshold distance may be smaller when the vehicle 200 is traveling at a faster speed than when the vehicle 200 is traveling at a slower speed. Similarly, the threshold distance may be smaller when the object is moving faster than the vehicle 200 (in the same direction) than when the object is moving at the same speed or slower (in the same direction) than the vehicle 200.

At block 1006, based on the detected change to the vehicle scene, the planning system 404 generates a plurality of second trajectories for the autonomous vehicle that are different from the first trajectory (also referred to herein as alternate trajectories or potential trajectories). In some cases, the planning system 404 may generate hundreds, thousands, or more alternate trajectories. In certain cases, the planning system 404 may generate the alternate trajectories using an MPC.

As described herein, the alternate trajectories may include a lateral movement so that the object that moved into the path of the vehicle 200 is no longer in the path of the vehicle 200. In some cases, the lateral movement may include a lane change and the alternate trajectory may be based on a changed homotopy decision to “change lane.” Moreover, the alternate trajectories may vary from each other in terms of when lateral movement begins/ends, speed of lateral movement, acceleration of lateral movement, etc.

In some cases, the planning system 404 may generate the alternate trajectories based on one or more constraints, such as a time or lateral movement constraint. For example, the planning system 404 may calculate a distance to the object and/or a time to impact (e.g., if the object does not move or accelerate), and generate the trajectories to avoid impact with the object (e.g., move a particular lateral distance before the estimated time of impact or before the calculated distance is reached) with varying levels of lateral acceleration, start/stop time (e.g., when lateral movement begins/ends), etc.

At block 1008, the planning system 404 compares the alternate trajectories with the current trajectory. In some such cases, the planning system 404 compares the lateral path of the alternate trajectories with the lateral path of the current trajectory to determine the difference between them at one or more points in time. For example, the planning system 404 may compare the lateral position of an alternate trajectory with the lateral position of the current trajectory at time t=0, 1, 2, 3, etc. As another example, as described herein at least with reference to FIG. 8B, at one or more time periods, the alternate trajectory may maintain continuity with the current trajectory and at other times, the alternate trajectory may deviate from the current trajectory. The planning system 404 may identify these deviations.

In certain cases, the planning system 404 uses the difference between the lateral position of the alternate trajectory with the lateral position of the current trajectory to determine one or more lateral path deviations of the alternate trajectory from the current trajectory. In some cases, the planning system 404 may generate a B-spline representation of the current trajectory and use the B-spline representation to compare the current trajectory with the alternate trajectories.

At block 1010, the planning system 404 selects a particular trajectory from plurality of potential trajectories for the autonomous vehicle based on the comparison of the alternate trajectory with the current trajectory. In certain cases, the planning system 404 selects the particular trajectory based on a determination that the particular trajectory satisfies one or more lateral acceleration or velocity thresholds. For example, the planning system 404 may select a particular trajectory based on a determination that the particular trajectory does not laterally accelerate more than the threshold amount that would cause discomfort or injury to a passenger.

In some cases, the planning system 404 selects the particular trajectory based on a lateral movement plan. As described herein, lateral movement plan may be configured to reduce the likelihood that the lateral acceleration of a corresponding trajectory will cause discomfort or injury to passengers.

In some such cases, based on the comparison of the alternate trajectories with the current (or first) trajectory, the planning system 404 may use the lateral movement plan to score or penalize the different trajectories. In certain cases, based on the lateral movement plan, the planning system 404 may select the alternate trajectory with a particular (e.g., highest) score or a particular (e.g., lowest) penalty as the subsequent trajectory.

In some cases, the planning system 404 may compare one or more deviations of the alternate trajectories (including the particular trajectory) from the current trajectory with the lateral movement plan and select the particular trajectory based on the comparison. For example, the lateral movement plan may indicate how to score or penalize particular deviations at different times. The planning system 404 may use the indications for scores/penalties from the lateral movement plan to score/penalize the alternate trajectories and select the subsequent trajectory. In this way, the lateral movement plan may affect the scores and/or rankings of the alternate trajectories, and selection of the subsequent (or particular) trajectory.

Whether to penalize (or score lower) a particular alternate trajectory and the amount of the penalty may be determined by the lateral movement plan. For example, the planning system 404 may apply a larger penalty (or lower score) to larger deviations and a smaller penalty (or higher score) to smaller deviations.

In some cases, the lateral movement plan may apply different levels of penalties (or different scores) at different times for the same sized deviation (between the lateral position of the alternate trajectory and the lateral position of the current trajectory at a particular time). Accordingly, the same amount of deviation (at a particular time) between the lateral position of an alternate trajectory and the lateral position of the current trajectory may result in a larger or smaller penalty (or correspondingly lower or higher score) based on the lateral movement plan. For example, in some cases, based on the lateral movement plan, the planning system 404 may not penalize the alternate trajectory for deviating from the current trajectory at a first time and penalize the alternate trajectory for deviating from the current trajectory at a second time (for the same size or different sized deviation).

As described herein, the lateral movement plan may indicate a lateral path commitment level at different times. As described herein, the lateral path commitment level may vary over time in a stepwise, continuous, or piecewise manner. The planning system 404 may use the lateral path commitment level at different times to evaluate the alternate trajectories.

In some cases, the planning system 404 may score or penalize the trajectories based on how closely the deviations approximate the lateral path commitment level of the lateral movement plan over time. In some cases, the planning system 404 may select the trajectory whose deviations more closely (or most closely) approximate the lateral path commitment level (over time) or expected deviations of the lateral movement plan as the particular or subsequent trajectory.

In certain cases, the planning system 404 may compare one or more deviations between the lateral position of the alternate trajectories and the lateral position of the current trajectory at different times with the lateral path commitment level (at corresponding times) of the lateral movement plan. Based on the comparison, the planning system 404 may score or penalize the different trajectories. In some cases, the planning system 404 may select the alternate trajectory with a particular (e.g., highest) score or a particular (e.g., lowest) penalty as the subsequent trajectory.

In some cases, based on the lateral path commitment level (at a particular time) of a lateral movement plan, the planning system 404 may penalize the potential trajectories for deviating from the lateral path of the current trajectory at different amounts. For example, if the lateral path commitment level is relatively higher, deviations from the first trajectory may result in higher penalties (or lower scores) than for the same deviation when the lateral path commitment level is lower. Accordingly, the same amount of deviation (at a particular time) between the lateral position of an alternate trajectory and the lateral position of the current trajectory may result in a larger or smaller penalty (or correspondingly lower or higher score) based on the lateral path commitment level (at that time). In this way, the lateral path commitment level may affect the evaluation of the alternate trajectories, and the selection of the subsequent (or particular) trajectory.

In some cases, the planning system 404 may penalize/score the trajectories based on multiple scores/penalties corresponding to multiple deviations of a trajectory. For example, the planning system 404 may determine a score or penalty for some or all deviations of an alternate trajectory based on the lateral path commitment level for the time corresponding to the deviation. The planning system 404 may combine the different penalties/scores from the different deviations to determine a score/penalty for the trajectory. Accordingly, the planning system 404 may compare the combination of scores/penalties from multiple deviations (or aggregate score/penalty) of an alternate trajectory with the combination of scores/penalties from multiple deviations (or aggregate score/penalty) of another trajectory to evaluate the trajectories and select the subsequent trajectory.

As a non-limiting example, the planning system 404 may determine first and second penalties for a first alternate trajectory based on corresponding first and second deviations of the first alternate trajectory and the lateral path commitment level (for the time corresponding to the deviations), and determine third and fourth penalties for a second alternate trajectory based on corresponding third and fourth deviations of the second alternate trajectory and the lateral path commitment level (for the time corresponding to the deviations). Moreover, the planning system 404 may use the combination of the first and second penalties and the combination of the second and third penalties to compare the first alternate trajectory and the second alternate trajectory. Based on the comparison, the planning system 404 may select the subsequent trajectory (e.g., the trajectory with the higher score or lower penalty).

At block 1012, the planning system 404 causes the autonomous vehicle to be navigated according to the particular trajectory. As described herein, the planning system 404 may communicate the selected trajectory to the control system 408, which may adjust one or more control parameters (e.g., steering wheel, accelerator, decelerator, etc.) to cause the vehicle 200 to move in a manner that (approximately) tracks the selected trajectory.

In some embodiments, the planning system 404 may use different lateral movement plans based on different scenarios. For example, there is a higher possibility of a pedestrian lane incursion at intersections, and thus the lateral path commitment level of the lateral movement plan for such a scenario can be lowered to allow for aggressive evasive maneuvers at intersections. Other scenarios which may use different lateral movement plans (and therefore vary in the level of aggressive lateral movement) can have different costs include residential neighborhoods, highways etc. The lateral path commitment levels for different lateral movement plans may also vary depending on the amount of lateral movement required (within a particular amount of time or distance) for a given trajectory.

Fewer, more, or different blocks can be included in the routine 900 and/or the blocks can be reordered. In some cases, the routine can be repeated hundreds, thousands, or millions of times as the vehicle 200 operates. For example, the routine 900 may occur multiple times a second while a vehicle 200 is in operation.

Aspects of this disclosure provide one or more advantages over other systems for generating autonomous vehicle trajectories. For example, this disclosure can generate trajectories with smoother lateral maneuvers, for example, during lane changes. In some embodiments, the generation of trajectories according to aspects of this disclosure may result in a reduction of the maximum steering rate by a factor of two or more. The system may also reduce the amount of aggressive lateral movements.

### Examples

Various example embodiments of the disclosure can be described by the following clauses:

Clause 1. A method for operating an autonomous vehicle, the method comprising: obtaining scene data associated with a scene of an autonomous vehicle, the autonomous vehicle navigating the scene according to a first trajectory; detecting a change to the scene based on the scene data; based on the change to the vehicle scene, generating a plurality of second trajectories, wherein the plurality of second trajectories are different from the first trajectory; comparing the plurality of second trajectories with the first trajectory; selecting a particular trajectory of the plurality of second trajectories for the autonomous vehicle based on a lateral movement plan and the comparing the plurality of second trajectories with the first trajectory; and navigating the autonomous vehicle according to the particular trajectory.

Clause 2. The method of claim 1, wherein selecting the particular trajectory further comprises: determining at least one deviation of the particular trajectory from a lateral path of the first trajectory; comparing the at least one deviation of the particular trajectory with the lateral movement plan; and selecting the particular trajectory based on the comparing the at least one deviation with the lateral movement plan.

Clause 3. The method of claim 2, wherein comparing the at least one deviation of the particular trajectory with the lateral movement plan comprises comparing the at least one deviation of the particular trajectory with a lateral path commitment level of the lateral movement plan; and wherein selecting the particular trajectory based on the comparing the at least one deviation with the lateral movement plan comprises selecting the particular trajectory based on the comparing the at least one deviation with the at least one lateral path commitment level.

Clause 4. The method of claim 3, wherein the at least one lateral path commitment level varies over time.

Clause 5. The method of claim 4, wherein the at least one lateral path commitment level varies over time in a continuous manner.

Clause 6. The method of claim 4, wherein the at least one lateral path commitment level varies over time in a stepwise manner.

Clause 7. The method of any of claims 1-6, wherein comparing the plurality of second trajectories with the first trajectory comprises comparing at least one lateral position of each of the plurality of trajectories with at least one lateral position of the first trajectory at a corresponding time, and wherein selecting the particular trajectory of the plurality of second trajectories for the autonomous vehicle based on the comparing the plurality of second trajectories comprises selecting the particular trajectory based on the comparing the at least one lateral position of each of the plurality of trajectories with the at least one lateral position of the first trajectory.

Clause 8. The method of any of claims 1-7, wherein selecting the particular trajectory further comprises: determining at least one first deviation of another trajectory of the plurality of second trajectories from a lateral path of the first trajectory; determining at least one second deviation of the particular trajectory from the lateral path of the first trajectory; and selecting the particular trajectory based on a determination that the at least one first deviation of the another trajectory is greater than the at least one second deviation of the particular trajectory.

Clause 9. The method of any of claims 1-8, wherein selecting the particular trajectory further comprises: determining at least one first deviation of the particular trajectory from a lateral path of the first trajectory at a first time and at least one second deviation of the particular trajectory from the lateral path at a second time; determining a first penalty for the particular trajectory based on the at least one first deviation and a lateral path commitment level of the lateral movement plan at the first time; determining a second penalty for the particular trajectory based one the at least one second deviation and the lateral path commitment level at the second time, wherein the second penalty is different than the first penalty; and selecting the particular trajectory for the autonomous vehicle based on the first penalty and the second penalty.

Clause 10. The method of any of claims 1-9, wherein selecting the particular trajectory further comprises: determining at least one first deviation of another trajectory of the plurality of second trajectories from a lateral path of the first trajectory at a first time and at least one second deviation of the another trajectory from the lateral path at a second time; determining a first penalty for the another trajectory based on the at least one first deviation and a lateral path commitment level of the lateral movement plan at the first time; determining a second penalty for the another trajectory based on the at least one second deviation and the lateral path commitment level at the second time; determining at least one third deviation of the particular trajectory from the lateral path at the first time and at least one fourth deviation of the particular trajectory from the lateral path at the second time; determining a third penalty for the particular trajectory based on the at least one third deviation and the lateral path commitment level at the first time; determining a fourth penalty for the particular trajectory based one the at least one fourth deviation and the lateral path commitment level at the second time; and selecting the particular trajectory for the autonomous vehicle based on the first penalty, the second penalty, the third penalty, and the fourth penalty.

Clause 11. The method of claim 10, wherein selecting the particular trajectory for the autonomous vehicle based on the first penalty, the second penalty, the third penalty, and the fourth penalty comprises selecting the particular trajectory for the autonomous vehicle based on a combination of the first penalty and the second penalty compared with a combination of the third penalty and the fourth penalty.

Clause 12. The method of any of claims 1-11, wherein selecting the particular trajectory further comprises: determining a plurality of deviations of the particular trajectory from the first trajectory, the plurality of deviations corresponding to respective points in time along the particular trajectory and the first trajectory; comparing the plurality of deviations with a lateral path commitment level of the lateral movement plan at the respective points in time, wherein the lateral path commitment level varies over time; scoring the particular trajectory based on the comparing the plurality of deviations with the lateral path commitment level at the respective points in time; and selecting the particular trajectory for the autonomous vehicle based on the scoring the particular trajectory.

Clause 13. The method of any of claims 1-12, wherein selecting the particular trajectory further comprises: determining a plurality of deviations of the particular trajectory from the first trajectory, the plurality of deviations corresponding to respective points in time along the particular trajectory and the first trajectory; comparing the plurality of deviations with a lateral path commitment level of the lateral movement plan at the respective points in time, wherein the lateral path commitment level varies over time; determining a plurality of penalties for the particular trajectory based on the comparing the plurality of deviations with the lateral path commitment level at the respective times, wherein a particular penalty of the plurality of penalties corresponds to a particular deviation of the plurality of deviations; and selecting the particular trajectory for the autonomous vehicle based on the plurality of penalties.

Clause 14. The method of any of claims 1-13, further comprising: generating a B-spline representation of the current trajectory, wherein comparing the plurality of second trajectories with the first trajectory comprises comparing the plurality of second trajectories with the first trajectory using the B-spline representation of the current trajectory.

Clause 15. The method of claim 14, wherein selecting the particular trajectory of the plurality of second trajectories for the autonomous vehicle based on the comparing the plurality of second trajectories with the first trajectory and the lateral movement plan comprises selecting the particular trajectory based on the comparing the plurality of second trajectories with the first trajectory, the lateral movement plan comprises, and a determination that the particular trajectory satisfies a lateral acceleration threshold.

Clause 16. The method of any of claims 1-15, further comprising: identifying a scenario in the scene based on the detecting the change to the vehicle scene; and selecting the lateral movement plan from a plurality of lateral movement plans based the identifying the scenario.

Clause 17. The method of any of claims 1-16, wherein detecting a change to the scene based on the scene data comprises: identifying a vehicle entering a same lane as the autonomous vehicle; and determining that the vehicle entering the same lane as the autonomous vehicle is within a threshold distance of the autonomous vehicle.

Clause 18. The method of claim 17, wherein detecting a change to the vehicle scene based on the scene data comprises: identifying a pedestrian entering a same lane as the autonomous vehicle; and determining that the pedestrian entering the same lane as the autonomous vehicle is within a threshold distance of the autonomous vehicle.

Clause 19. The method of any of claims 1-18, wherein detecting a change to the vehicle scene based on the scene data comprises receiving at least one homotopy decision that differs from a previous homotopy decision.

Clause 20. A system, comprising: at least one processor, and at least one non-transitory storage media storing instructions that, when executed by the at least one processor, cause the at least one processor to: obtain scene data associated with a scene of an autonomous vehicle, the autonomous vehicle navigating the scene according to a first trajectory; detect a change to the scene based on the scene data; based on the change to the vehicle scene, generate a plurality of second trajectories, wherein the plurality of second trajectories are different from the first trajectory; compare the plurality of second trajectories with the first trajectory; select a particular trajectory of the plurality of second trajectories for the autonomous vehicle based on a lateral movement plan and the comparing the plurality of second trajectories with the first trajectory; and navigate the autonomous vehicle according to the particular trajectory.

Clause 21. The system of claim 20, wherein the instructions that cause the at least one processor to select the particular trajectory cause the at least one processor to: determine at least one deviation of the particular trajectory from a lateral path of the first trajectory; compare the at least one deviation of the particular trajectory with the lateral movement plan; and select the particular trajectory based on the comparing the at least one deviation with the lateral movement plan.

Clause 22. The system of claim 21, wherein the instructions that cause the at least one processor to compare the at least one deviation of the particular trajectory with the lateral movement plan cause the at least one processor to compare the at least one deviation of the particular trajectory with a lateral path commitment level of the lateral movement plan; and wherein the instructions that cause the at least one processor to select the particular trajectory based on the comparing the at least one deviation with the lateral movement plan cause the at least one processor to select the particular trajectory based on the comparing the at least one deviation with the at least one lateral path commitment level.

Clause 23. The system of claim 22, wherein the at least one lateral path commitment level varies over time.

Clause 24. The system of claim 23, wherein the at least one lateral path commitment level varies over time in a continuous manner.

Clause 25. The system of claim 23, wherein the at least one lateral path commitment level varies over time in a stepwise manner.

Clause 26. The system of any of claims 20-25, wherein the instructions that cause the at least one processor to compare the plurality of second trajectories with the first trajectory cause the at least one processor to compare at least one lateral position of each of the plurality of trajectories with at least one lateral position of the first trajectory at a corresponding time, and wherein the instructions that cause the at least one processor to select the particular trajectory of the plurality of second trajectories for the autonomous vehicle based on the comparing the plurality of second trajectories cause the at least one processor to select the particular trajectory based on the comparing the at least one lateral position of each of the plurality of trajectories with the at least one lateral position of the first trajectory.

Clause 27. The system of any of claims 20-26, wherein the instructions that cause the at least one processor to select the particular trajectory cause the at least one processor to: determine at least one first deviation of another trajectory of the plurality of second trajectories from a lateral path of the first trajectory; determine at least one second deviation of the particular trajectory from the lateral path of the first trajectory; and select the particular trajectory based on a determination that the at least one first deviation of the another trajectory is greater than the at least one second deviation of the particular trajectory.

Clause 28. The system of any of claims 20-27, wherein the instructions that cause the at least one processor to select the particular trajectory cause the at least one processor to: determine at least one first deviation of the particular trajectory from a lateral path of the first trajectory at a first time and at least one second deviation of the particular trajectory from the lateral path at a second time; determine a first penalty for the particular trajectory based on the at least one first deviation and a lateral path commitment level of the lateral movement plan at the first time; determine a second penalty for the particular trajectory based one the at least one second deviation and the lateral path commitment level at the second time, wherein the second penalty is different than the first penalty; and select the particular trajectory for the autonomous vehicle based on the first penalty and the second penalty.

Clause 29. The system of any of claims 20-28, wherein the instructions that cause the at least one processor to select the particular trajectory cause the at least one processor to: determine at least one first deviation of another trajectory of the plurality of second trajectories from a lateral path of the first trajectory at a first time and at least one second deviation of the another trajectory from the lateral path at a second time; determine a first penalty for the another trajectory based on the at least one first deviation and a lateral path commitment level of the lateral movement plan at the first time; determine a second penalty for the another trajectory based on the at least one second deviation and the lateral path commitment level at the second time; determine at least one third deviation of the particular trajectory from the lateral path at the first time and at least one fourth deviation of the particular trajectory from the lateral path at the second time; determine a third penalty for the particular trajectory based on the at least one third deviation and the lateral path commitment level at the first time; determine a fourth penalty for the particular trajectory based one the at least one fourth deviation and the lateral path commitment level at the second time; and select the particular trajectory for the autonomous vehicle based on the first penalty, the second penalty, the third penalty, and the fourth penalty.

Clause 30. The system of claim 29, wherein the instructions that cause the at least one processor to select the particular trajectory for the autonomous vehicle based on the first penalty, the second penalty, the third penalty, and the fourth penalty cause the at least one processor to select the particular trajectory for the autonomous vehicle based on a combination of the first penalty and the second penalty compared with a combination of the third penalty and the fourth penalty.

Clause 31. The system of any of claims 20-30, wherein the instructions that cause the at least one processor to select the particular trajectory cause the at least one processor to: determine a plurality of deviations of the particular trajectory from the first trajectory, the plurality of deviations corresponding to respective points in time along the particular trajectory and the first trajectory; compare the plurality of deviations with a lateral path commitment level of the lateral movement plan at the respective points in time, wherein the lateral path commitment level varies over time; score the particular trajectory based on the comparing the plurality of deviations with the lateral path commitment level at the respective points in time; and select the particular trajectory for the autonomous vehicle based on the scoring the particular trajectory.

Clause 32. The system of any of claims 20-31, wherein the instructions that cause the at least one processor to select the particular trajectory cause the at least one processor to: determine a plurality of deviations of the particular trajectory from the first trajectory, the plurality of deviations corresponding to respective points in time along the particular trajectory and the first trajectory; compare the plurality of deviations with a lateral path commitment level of the lateral movement plan at the respective points in time, wherein the lateral path commitment level varies over time; determine a plurality of penalties for the particular trajectory based on the comparing the plurality of deviations with the lateral path commitment level at the respective times, wherein a particular penalty of the plurality of penalties corresponds to a particular deviation of the plurality of deviations; and select the particular trajectory for the autonomous vehicle based on the plurality of penalties.

Clause 33. The system of any of claims 20-32, wherein the instructions further cause the at least one processor to: generate a B-spline representation of the current trajectory, wherein the instructions that cause the at least one processor to compare the plurality of second trajectories with the first trajectory cause the at least one processor to compare the plurality of second trajectories with the first trajectory using the B-spline representation of the current trajectory.

Clause 34. The system of claim 33, wherein the instructions that cause the at least one processor to select the particular trajectory of the plurality of second trajectories for the autonomous vehicle based on the comparing the plurality of second trajectories with the first trajectory and the lateral movement plan cause the at least one processor to select the particular trajectory based on the comparing the plurality of second trajectories with the first trajectory, the lateral movement plan comprises, and a determination that the particular trajectory satisfies a lateral acceleration threshold.

Clause 35. The system of any of claims 20-34, wherein the instructions further cause the at least one processor to: identify a scenario in the scene based on the detecting the change to the vehicle scene; and select the lateral movement plan from a plurality of lateral movement plans based the identifying the scenario.

Clause 36. The system of any of claims 20-35, wherein the instructions that cause the at least one processor to detect a change to the scene based on the scene data cause the at least one processor to: identify a vehicle entering a same lane as the autonomous vehicle; and determine that the vehicle entering the same lane as the autonomous vehicle is within a threshold distance of the autonomous vehicle.

Clause 37. The system of claim 36, wherein the instructions that cause the at least one processor to detect a change to the vehicle scene based on the scene data cause the at least one processor to: identify a pedestrian entering a same lane as the autonomous vehicle; and determine that the pedestrian entering the same lane as the autonomous vehicle is within a threshold distance of the autonomous vehicle.

Clause 38. The system of any of claims 20-37, wherein the instructions that cause the at least one processor to detect a change to the vehicle scene based on the scene data cause the at least one processor to receive at least one homotopy decision that differs from a previous homotopy decision.

Clause 39. At least one non-transitory storage media storing instructions that, when executed by at least one processor, cause the at least one processor to: obtain scene data associated with a scene of an autonomous vehicle, the autonomous vehicle navigating the scene according to a first trajectory; detect a change to the scene based on the scene data; based on the change to the vehicle scene, generate a plurality of second trajectories, wherein the plurality of second trajectories are different from the first trajectory; compare the plurality of second trajectories with the first trajectory; select a particular trajectory of the plurality of second trajectories for the autonomous vehicle based on a lateral movement plan and the comparing the plurality of second trajectories with the first trajectory; and navigate the autonomous vehicle according to the particular trajectory.

Clause 40. The at least one non-transitory storage media of claim 39, wherein the instructions that cause the at least one processor to select the particular trajectory cause the at least one processor to: determine at least one deviation of the particular trajectory from a lateral path of the first trajectory; compare the at least one deviation of the particular trajectory with the lateral movement plan; and select the particular trajectory based on the comparing the at least one deviation with the lateral movement plan.

Clause 41. The at least one non-transitory storage media of claim 40, wherein the instructions that cause the at least one processor to compare the at least one deviation of the particular trajectory with the lateral movement plan cause the at least one processor to compare the at least one deviation of the particular trajectory with a lateral path commitment level of the lateral movement plan; and wherein the instructions that cause the at least one processor to select the particular trajectory based on the comparing the at least one deviation with the lateral movement plan cause the at least one processor to select the particular trajectory based on the comparing the at least one deviation with the at least one lateral path commitment level.

Clause 42. The at least one non-transitory storage media of claim 41, wherein the at least one lateral path commitment level varies over time.

Clause 43. The at least one non-transitory storage media of claim 42, wherein the at least one lateral path commitment level varies over time in a continuous manner.

Clause 44. The at least one non-transitory storage media of claim 42, wherein the at least one lateral path commitment level varies over time in a stepwise manner.

Clause 45. The at least one non-transitory storage media of any of claims 39-44, wherein the instructions that cause the at least one processor to compare the plurality of second trajectories with the first trajectory cause the at least one processor to compare at least one lateral position of each of the plurality of trajectories with at least one lateral position of the first trajectory at a corresponding time, and wherein the instructions that cause the at least one processor to select the particular trajectory of the plurality of second trajectories for the autonomous vehicle based on the comparing the plurality of second trajectories cause the at least one processor to select the particular trajectory based on the comparing the at least one lateral position of each of the plurality of trajectories with the at least one lateral position of the first trajectory.

Clause 46. The at least one non-transitory storage media of any of claims 39-45, wherein the instructions that cause the at least one processor to select the particular trajectory cause the at least one processor to: determine at least one first deviation of another trajectory of the plurality of second trajectories from a lateral path of the first trajectory; determine at least one second deviation of the particular trajectory from the lateral path of the first trajectory; and select the particular trajectory based on a determination that the at least one first deviation of the another trajectory is greater than the at least one second deviation of the particular trajectory.

Clause 47. The at least one non-transitory storage media of any of claims 39-46, wherein the instructions that cause the at least one processor to select the particular trajectory cause the at least one processor to: determine at least one first deviation of the particular trajectory from a lateral path of the first trajectory at a first time and at least one second deviation of the particular trajectory from the lateral path at a second time; determine a first penalty for the particular trajectory based on the at least one first deviation and a lateral path commitment level of the lateral movement plan at the first time; determine a second penalty for the particular trajectory based one the at least one second deviation and the lateral path commitment level at the second time, wherein the second penalty is different than the first penalty; and select the particular trajectory for the autonomous vehicle based on the first penalty and the second penalty.

Clause 48. The at least one non-transitory storage media of any of claims 39-47, wherein the instructions that cause the at least one processor to select the particular trajectory cause the at least one processor to: determine at least one first deviation of another trajectory of the plurality of second trajectories from a lateral path of the first trajectory at a first time and at least one second deviation of the another trajectory from the lateral path at a second time; determine a first penalty for the another trajectory based on the at least one first deviation and a lateral path commitment level of the lateral movement plan at the first time; determine a second penalty for the another trajectory based on the at least one second deviation and the lateral path commitment level at the second time; determine at least one third deviation of the particular trajectory from the lateral path at the first time and at least one fourth deviation of the particular trajectory from the lateral path at the second time; determine a third penalty for the particular trajectory based on the at least one third deviation and the lateral path commitment level at the first time; determine a fourth penalty for the particular trajectory based one the at least one fourth deviation and the lateral path commitment level at the second time; and select the particular trajectory for the autonomous vehicle based on the first penalty, the second penalty, the third penalty, and the fourth penalty.

Clause 49. The at least one non-transitory storage media of claim 48, wherein the instructions that cause the at least one processor to select the particular trajectory for the autonomous vehicle based on the first penalty, the second penalty, the third penalty, and the fourth penalty cause the at least one processor to select the particular trajectory for the autonomous vehicle based on a combination of the first penalty and the second penalty compared with a combination of the third penalty and the fourth penalty.

Clause 50. The at least one non-transitory storage media of any of claims 39-49, wherein the instructions that cause the at least one processor to select the particular trajectory cause the at least one processor to: determine a plurality of deviations of the particular trajectory from the first trajectory, the plurality of deviations corresponding to respective points in time along the particular trajectory and the first trajectory; compare the plurality of deviations with a lateral path commitment level of the lateral movement plan at the respective points in time, wherein the lateral path commitment level varies over time; score the particular trajectory based on the comparing the plurality of deviations with the lateral path commitment level at the respective points in time; and select the particular trajectory for the autonomous vehicle based on the scoring the particular trajectory.

Clause 51. The at least one non-transitory storage media of any of claims 39-50, wherein the instructions that cause the at least one processor to select the particular trajectory cause the at least one processor to: determine a plurality of deviations of the particular trajectory from the first trajectory, the plurality of deviations corresponding to respective points in time along the particular trajectory and the first trajectory; compare the plurality of deviations with a lateral path commitment level of the lateral movement plan at the respective points in time, wherein the lateral path commitment level varies over time; determine a plurality of penalties for the particular trajectory based on the comparing the plurality of deviations with the lateral path commitment level at the respective times, wherein a particular penalty of the plurality of penalties corresponds to a particular deviation of the plurality of deviations; and select the particular trajectory for the autonomous vehicle based on the plurality of penalties.

Clause 52. The at least one non-transitory storage media of any of claims 39-51, wherein the instructions further cause the at least one processor to: generate a B-spline representation of the current trajectory, wherein the instructions that cause the at least one processor to compare the plurality of second trajectories with the first trajectory cause the at least one processor to compare the plurality of second trajectories with the first trajectory using the B-spline representation of the current trajectory.

Clause 53. The at least one non-transitory storage media of claim 52, wherein the instructions that cause the at least one processor to select the particular trajectory of the plurality of second trajectories for the autonomous vehicle based on the comparing the plurality of second trajectories with the first trajectory and the lateral movement plan cause the at least one processor to select the particular trajectory based on the comparing the plurality of second trajectories with the first trajectory, the lateral movement plan comprises, and a determination that the particular trajectory satisfies a lateral acceleration threshold.

Clause 54. The at least one non-transitory storage media of any of claims 39-53, wherein the instructions further cause the at least one processor to: identify a scenario in the scene based on the detecting the change to the vehicle scene; and select the lateral movement plan from a plurality of lateral movement plans based the identifying the scenario.

Clause 55. The at least one non-transitory storage media of any of claims 39-54, wherein the instructions that cause the at least one processor to detect a change to the scene based on the scene data cause the at least one processor to: identify a vehicle entering a same lane as the autonomous vehicle; and determine that the vehicle entering the same lane as the autonomous vehicle is within a threshold distance of the autonomous vehicle.

Clause 56. The at least one non-transitory storage media of claim 55, wherein the instructions that cause the at least one processor to detect a change to the vehicle scene based on the scene data cause the at least one processor to: identify a pedestrian entering a same lane as the autonomous vehicle; and determine that the pedestrian entering the same lane as the autonomous vehicle is within a threshold distance of the autonomous vehicle.

Clause 57. The at least one non-transitory storage media of any of claims 39-56, wherein the instructions that cause the at least one processor to detect a change to the vehicle scene based on the scene data cause the at least one processor to receive at least one homotopy decision that differs from a previous homotopy decision.

All of the methods and tasks described herein may be performed and fully automated by a computer system. The computer system may, in some cases, include multiple distinct computers or computing devices that communicate and interoperate over a network to perform the described functions. Each such computing device typically includes a processor (or multiple processors) that executes program instructions or modules stored in a memory or other non-transitory computer-readable storage medium or device (e.g., solid state storage devices, disk drives, etc.). The various functions disclosed herein may be embodied in such program instructions or may be implemented in application-specific circuitry (e.g., ASICs or FPGAs) of the computer system. Where the computer system includes multiple computing devices, these devices may be co-located. The results of the disclosed methods and tasks may be persistently stored by transforming physical storage devices, such as solid-state memory chips or magnetic disks, into a different state.

The processes described herein or illustrated in the figures of the present disclosure may begin in response to an event, such as on a predetermined or dynamically determined schedule, on demand when initiated by a user or system administrator, or in response to some other event. When such processes are initiated, a set of executable program instructions stored on one or more non-transitory computer-readable media (e.g., hard drive, flash memory, removable media, etc.) may be loaded into memory (e.g., RAM) of a server or other computing device. The executable instructions may then be executed by a hardware-based computer processor of the computing device. In some embodiments, such processes or portions thereof may be implemented on multiple computing devices and/or multiple processors, serially or in parallel.

Depending on the embodiment, certain acts, events, or functions of any of the processes or algorithms described herein can be performed in a different sequence, can be added, merged, or left out altogether (e.g., not all described operations or events are necessary for the practice of the algorithm). Moreover, in certain embodiments, operations or events can be performed concurrently, e.g., through multi-threaded processing, interrupt processing, or multiple processors or processor cores or on other parallel architectures, rather than sequentially.

The various illustrative logical blocks, modules, routines, and algorithm steps described in connection with the embodiments disclosed herein can be implemented as electronic hardware (e.g., ASICs or FPGA devices), computer software that runs on computer hardware, or combinations of both. Moreover, the various illustrative logical blocks and modules described in connection with the embodiments disclosed herein can be implemented or performed by a machine, such as a processor device, a digital signal processor (“DSP”), an application specific integrated circuit (“ASIC”), a field programmable gate array (“FPGA”) or other programmable logic device, discrete gate or transistor logic, discrete hardware components, or any combination thereof designed to perform the functions described herein. A processor device can be a microprocessor, but in the alternative, the processor device can be a controller, microcontroller, or state machine, combinations of the same, or the like. A processor device can include electrical circuitry configured to process computer-executable instructions. In another embodiment, a processor device includes an FPGA or other programmable device that performs logic operations without processing computer-executable instructions. A processor device can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor device may also include primarily analog components. For example, some or all of the rendering techniques described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

The elements of a method, process, routine, or algorithm described in connection with the embodiments disclosed herein can be embodied directly in hardware, in a software module executed by a processor device, or in a combination of the two. A software module can reside in RAM memory, flash memory, ROM memory, EPROM memory, EEPROM memory, registers, hard disk, a removable disk, a CD-ROM, or any other form of a non-transitory computer-readable storage medium. An exemplary storage medium can be coupled to the processor device such that the processor device can read information from, and write information to, the storage medium. In the alternative, the storage medium can be integral to the processor device. The processor device and the storage medium can reside in an ASIC. The ASIC can reside in a user terminal. In the alternative, the processor device and the storage medium can reside as discrete components in a user terminal.

In the foregoing description, aspects and embodiments of the present disclosure have been described with reference to numerous specific details that can vary from implementation to implementation. Accordingly, the description and drawings are to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction. Any definitions expressly set forth herein for terms contained in such claims shall govern the meaning of such terms as used in the claims. In addition, when we use the term “further comprising,” in the foregoing description or following claims, what follows this phrase can be an additional step or entity, or a sub-step/sub-entity of a previously-recited step or entity.

What is claimed is:

1. A method for operating an autonomous vehicle, the method comprising:
obtaining scene data associated with a scene of an autonomous vehicle, the autonomous vehicle navigating the scene according to a first trajectory;
detecting a change to the scene based on the scene data;
based on the change to the vehicle scene, generating a plurality of second trajectories, wherein the plurality of second trajectories are different from the first trajectory;
comparing the plurality of second trajectories with the first trajectory;
selecting a particular trajectory of the plurality of second trajectories for the autonomous vehicle based on a lateral movement plan and the comparing the plurality of second trajectories with the first trajectory; and
navigating the autonomous vehicle according to the particular trajectory.

2. The method of claim 1, wherein selecting the particular trajectory further comprises:
determining at least one deviation of the particular trajectory from a lateral path of the first trajectory;
comparing the at least one deviation of the particular trajectory with the lateral movement plan; and
selecting the particular trajectory based on the comparing the at least one deviation with the lateral movement plan.

3. The method of claim 2,
wherein comparing the at least one deviation of the particular trajectory with the lateral movement plan comprises comparing the at least one deviation of the particular trajectory with a lateral path commitment level of the lateral movement plan; and
wherein selecting the particular trajectory based on the comparing the at least one deviation with the lateral movement plan comprises selecting the particular trajectory based on the comparing the at least one deviation with the at least one lateral path commitment level.

4. The method of claim 3, wherein the at least one lateral path commitment level varies over time.

5. The method of claim 4, wherein the at least one lateral path commitment level varies over time in a continuous manner.

6. The method of claim 4, wherein the at least one lateral path commitment level varies over time in a stepwise manner.

7. The method of claim 1,
wherein comparing the plurality of second trajectories with the first trajectory comprises comparing at least one lateral position of each of the plurality of trajectories with at least one lateral position of the first trajectory at a corresponding time, and
wherein selecting the particular trajectory of the plurality of second trajectories for the autonomous vehicle based on the comparing the plurality of second trajectories comprises selecting the particular trajectory based on the comparing the at least one lateral position of each of the plurality of trajectories with the at least one lateral position of the first trajectory.

8. The method of claim 1, wherein selecting the particular trajectory further comprises:
determining at least one first deviation of another trajectory of the plurality of second trajectories from a lateral path of the first trajectory;
determining at least one second deviation of the particular trajectory from the lateral path of the first trajectory; and
selecting the particular trajectory based on a determination that the at least one first deviation of the another trajectory is greater than the at least one second deviation of the particular trajectory.

9. The method of claim 1, wherein selecting the particular trajectory further comprises:
determining at least one first deviation of the particular trajectory from a lateral path of the first trajectory at a first time and at least one second deviation of the particular trajectory from the lateral path at a second time;
determining a first penalty for the particular trajectory based on the at least one first deviation and a lateral path commitment level of the lateral movement plan at the first time;
determining a second penalty for the particular trajectory based one the at least one second deviation and the lateral path commitment level at the second time, wherein the second penalty is different than the first penalty; and
selecting the particular trajectory for the autonomous vehicle based on the first penalty and the second penalty.

10. The method of claim 1, wherein selecting the particular trajectory further comprises:
determining at least one first deviation of another trajectory of the plurality of second trajectories from a lateral path of the first trajectory at a first time and at least one second deviation of the another trajectory from the lateral path at a second time;
determining a first penalty for the another trajectory based on the at least one first deviation and a lateral path commitment level of the lateral movement plan at the first time;
determining a second penalty for the another trajectory based on the at least one second deviation and the lateral path commitment level at the second time;
determining at least one third deviation of the particular trajectory from the lateral path at the first time and at least one fourth deviation of the particular trajectory from the lateral path at the second time;
determining a third penalty for the particular trajectory based on the at least one third deviation and the lateral path commitment level at the first time;
determining a fourth penalty for the particular trajectory based one the at least one fourth deviation and the lateral path commitment level at the second time; and
selecting the particular trajectory for the autonomous vehicle based on the first penalty, the second penalty, the third penalty, and the fourth penalty.

11. The method of claim 10, wherein selecting the particular trajectory for the autonomous vehicle based on the first penalty, the second penalty, the third penalty, and the fourth penalty comprises selecting the particular trajectory for the autonomous vehicle based on a combination of the first penalty and the second penalty compared with a combination of the third penalty and the fourth penalty.

12. The method of claim 1, wherein selecting the particular trajectory further comprises:
determining a plurality of deviations of the particular trajectory from the first trajectory, the plurality of deviations corresponding to respective points in time along the particular trajectory and the first trajectory;
comparing the plurality of deviations with a lateral path commitment level of the lateral movement plan at the respective points in time, wherein the lateral path commitment level varies over time;
scoring the particular trajectory based on the comparing the plurality of deviations with the lateral path commitment level at the respective points in time; and
selecting the particular trajectory for the autonomous vehicle based on the scoring the particular trajectory.

13. The method of claim 1, wherein selecting the particular trajectory further comprises:
determining a plurality of deviations of the particular trajectory from the first trajectory, the plurality of deviations corresponding to respective points in time along the particular trajectory and the first trajectory;
comparing the plurality of deviations with a lateral path commitment level of the lateral movement plan at the respective points in time, wherein the lateral path commitment level varies over time;
determining a plurality of penalties for the particular trajectory based on the comparing the plurality of deviations with the lateral path commitment level at the respective times, wherein a particular penalty of the plurality of penalties corresponds to a particular deviation of the plurality of deviations; and
selecting the particular trajectory for the autonomous vehicle based on the plurality of penalties.

14. A system, comprising:
at least one processor, and
at least one non-transitory storage media storing instructions that, when executed by the at least one processor, cause the at least one processor to:
obtain scene data associated with a scene of an autonomous vehicle, the autonomous vehicle navigating the scene according to a first trajectory;
detect a change to the scene based on the scene data;
based on the change to the vehicle scene, generate a plurality of second trajectories, wherein the plurality of second trajectories are different from the first trajectory;
compare the plurality of second trajectories with the first trajectory;
select a particular trajectory of the plurality of second trajectories for the autonomous vehicle based on a lateral movement plan and the comparing the plurality of second trajectories with the first trajectory; and
navigate the autonomous vehicle according to the particular trajectory.

15. The system of claim 14, wherein the instructions that cause the at least one processor to select the particular trajectory cause the at least one processor to:
determine at least one deviation of the particular trajectory from a lateral path of the first trajectory;
compare the at least one deviation of the particular trajectory with the lateral movement plan; and
select the particular trajectory based on the comparing the at least one deviation with the lateral movement plan.

16. The system of claim 15,
wherein the instructions that cause the at least one processor to compare the at least one deviation of the particular trajectory with the lateral movement plan cause the at least one processor to compare the at least one deviation of the particular trajectory with a lateral path commitment level of the lateral movement plan; and
wherein the instructions that cause the at least one processor to select the particular trajectory based on the comparing the at least one deviation with the lateral movement plan cause the at least one processor to select the particular trajectory based on the comparing the at least one deviation with the at least one lateral path commitment level.

17. The system of claim 16, wherein the at least one lateral path commitment level varies over time.

18. The system of claim 17, wherein the at least one lateral path commitment level varies over time in a continuous manner.

19. At least one non-transitory storage media storing instructions that, when executed by at least one processor, cause the at least one processor to:
obtain scene data associated with a scene of an autonomous vehicle, the autonomous vehicle navigating the scene according to a first trajectory;
detect a change to the scene based on the scene data;
based on the change to the vehicle scene, generate a plurality of second trajectories, wherein the plurality of second trajectories are different from the first trajectory;
compare the plurality of second trajectories with the first trajectory;
select a particular trajectory of the plurality of second trajectories for the autonomous vehicle based on a lateral movement plan and the comparing the plurality of second trajectories with the first trajectory; and
navigate the autonomous vehicle according to the particular trajectory.

20. The at least one non-transitory storage media of claim 19, wherein the instructions that cause the at least one processor to select the particular trajectory cause the at least one processor to:
determine at least one deviation of the particular trajectory from a lateral path of the first trajectory;
compare the at least one deviation of the particular trajectory with the lateral movement plan; and
select the particular trajectory based on the comparing the at least one deviation with the lateral movement plan.
